(19) United States
(12) Patent Application Publication
(10) Pub. No.: US 2020/0239762 A1
(43) Pub. Date: Jul. 30, 2020

(54) METHOD FOR EXTRACTING PETROLEUM FROM UNDERGROUND DEPOSITS HAVING HIGH TEMPERATURE AND SALINITY

(71) Applicants: BASF SE, Ludwigshafen am Rhein (DE); Wintershall Holding GmbH, Kassel (DE)

(72) Inventors: Christian BITTNER, Ludwigshafen am Rhein (DE); Guenter OETTER, Ludwigshafen am Rhein (DE); Christian SPINDLER, Ludwigshafen am Rhein (DE); Hans BULLIEN, Kassel (DE); David LEY, Ludwigshafen am Rhein (DE); Lorenz SIGGEL, Ludwigshafen am Rhein (DE)

(21) Appl. No.: 16/617,575

(22) PCT Filed: May 16, 2018
(86) PCT No.: PCT/EP2018/062786

§ 371 Date: Nov. 27, 2019

(30) Foreign Application Priority Data
May 30, 2017 (EP) 17173486.6

(51) Int. Cl. C09K 8/60; C09K 8/86; E21B 43/16

(52) U.S. Cl. CPC C09K 8/602; E21B 43/16; C09K 8/86

(57) ABSTRACT

The present invention relates to a method of producing mineral oil from underground mineral oil deposits, in which an aqueous saline surfactant formulation comprising a surfactant mixture, for the purpose of lowering the interfacial tension between oil and water to <0.1 mN/m, is injected into a mineral oil deposit through at least one injection well and crude oil is withdrawn from the deposit through at least one production well, wherein the mineral oil deposit has a temperature of ≥90° C. and a formation water having a salinity of ≥30 000 ppm of dissolved salts and wherein the surfactant mixture comprises at least one ionic surfactant (A) of the general formula (I)

(R¹)ₖ—N⁺(R²)₍₃₋ₖ₎R³(X⁻)ₗ (1)

and at least one anionic surfactant (B) of the general formula (II)

R⁴—O—(CH₂C(R⁵)HO)ₘ—(CH₂C(CH₃)HO)ₙ—(CH₂CH₂)ₒ—(CH₂)ₚ—Y⁻M⁺ (II)

with a molar ratio of ionic surfactant (A) to anionic surfactant (B) in the surfactant mixture on injection of 90:10 to 10:90, and where R¹ to R⁵, k, l, m, n, o, p, X, Y and M have the definition given in the claims and the description. The invention further relates to a concentrate comprising the surfactant (A), the surfactant (B) or the surfactant mixture.

The present invention relates to a method of producing mineral oil from underground mineral oil deposits, in which an aqueous saline surfactant formulation comprising a surfactant mixture, for the purpose of lowering the interfacial tension between oil and water to <0.1 mN/m, is injected into a mineral oil deposit through at least one injection well and crude oil is withdrawn from the deposit through at least one production well, wherein the mineral oil deposit has a temperature of ≥90° C. and a formation water having a salinity of >30 000 ppm of dissolved salts. The invention further relates to a concentrate comprising the surfactant (A), the surfactant (B) or the surfactant mixture.

Surfactants for mineral oil production (tertiary mineral oil production) are to have, among other properties, good solubility in saline water at reservoir temperature and give very low interfacial tensions (of less than 0.1 mN/m) with respect to the crude oil. Ideally, the surfactant solution is to form a Winsor type III microemulsion on contact with crude oil. The use of just one surfactant is usually very difficult, since it either has good solubility or gives low interfacial tensions (or Winsor type III microemulsions), but very often does not have both properties at the same time. This is especially true of mineral oil deposits at high temperature (for example 90° C. or higher) which simultaneously have formation water with high salinity (e.g. 100 000 ppm of dissolved salts (TDS=total dissolved salt) or more).

Olefinsulfonates or alkylarylsulfonates alone have inadequate tolerance to salt—especially in the presence of polyvalent cations such as calcium ions and magnesium ions. Alkyl alkoxylates used on their own have a cloud point below 90° C. with 100 000 ppm TDS.

As a result of the high temperatures, there is a requirement for thermally stable compounds that do not break down in the course of the flooding process. According to the distance from the injection well to the production well, this flooding process may result in exposure of the surfactants used to high temperatures over a period of half a year up to four years.

In many oil deposits composed of carbonate rock, the described conditions of high temperature and high salinity exist (for example in the Middle East: oil deposits in carbonate rock, called carbonate deposits, with >90° C. and >100 000 ppm TDS). The surfactants used should have a minimum tendency to adsorption on the carbonate rock. In the case of positively charged carbonate rocks, purely anionic surfactant mixtures have a high tendency to adsorption.

In the case of very high temperatures coupled with very high salinities (e.g. ≥125° C. and >210 000 ppm TDS), it is very difficult under reservoir conditions to achieve sufficient solubility of the surfactants in the deposit water and at the same time to bring about the formation of a Winsor type III microemulsion in the presence of crude oil.

DE 3446561 describes a method for producing surfactants of the type R′—(O—R)ₘ—(OCH₂CH₂)ₙ₋₁—OCH₂COOM, where R′ is said to be an alkyl radical having 1 to 20 carbon atoms and R is said to be an alkylene group having 3 to 5 carbon atoms. M is an alkali metal atom. Moreover, m is a number from 0 to 3 and n is a number from 2 to 30. The examples give details only of compounds for which R′ has at least 12 carbon atoms.

EP 0177098 describes a surfactant mixture for tertiary mineral oil production, consisting of an alkyl ether carboxylate and an alkylarylsulfonate. The alkyl radical of the alkyl ether carboxylate is said to have 6 to 20 carbon atoms. The examples give details only of compounds for which the alkyl radical has at least 12 carbon atoms.

US 2017/0066960 describes a surfactant mixture for tertiary mineral oil production that consists of an internal olefin sulfonate and an alkoxylated alcohol or a derivative of an alkoxylated alcohol. The derivative of an alkoxylated alcohol may be a compound containing carboxylate groups. The alkyl radical of the alkoxylated alcohol or of the derivative of an alkoxylated alcohol is said to represent 5 to 32 carbon atoms.

EP 0047370 describes the use of anionic surfactants of the type R—(OCH₂CH₂)ₙ—OCH₂COOM, which are based on an alkyl radical R having 6 to 20 carbon atoms or on an alkylated aromatic radical, the total number of the carbon atoms in the alkyl radicals being 1 to 14, in tertiary mineral oil production. With regard to the repeating units, n is a number from 3 to 30. M is an alkali metal atom. The examples give details only of compounds for which the alkyl radical has at least 12 carbon atoms.

EP 0047369 describes the use of anionic surfactants of the type R—(OCH₂CH₂)ₙ—OCH₂COOM, which are based on an alkyl or alkylaryl radical R having 4 to 20 carbon atoms or on an alkylated aromatic radical, the total number of the carbon atoms in the alkyl radicals being 1 to 14, in tertiary mineral oil production. With regard to the repeating units, n is a number from 3 to 15. M is an alkali metal atom or alkaline earth metal atom. The examples give details only of compounds for which the alkylaryl radical has at least 15 carbon atoms.

U.S. Pat. No. 4,457,373 A1 describes the use of water-in-oil emulsions of anionic surfactants of the type R—(OCH₂CH₂)ₙ—OCH₂COOM, which are based on an alkyl radical R having 6 to 20 carbon atoms or on an alkylated aromatic radical, the total number of the carbon atoms in the alkyl radicals being 3 to 28, in tertiary mineral oil production. With regard to the repeating units, n is a number from 1 to 30. The surfactants are produced via reaction of the corresponding alkoxylates with sodium chloroacetate and sodium hydroxide or aqueous soda lye. The carboxymethylation level may range from 10% to 100% (preferably 90-100%). The examples show only the use of water-in-oil emulsions with carboxymethylated sodium nonylphenol ethoxylate with e.g. n=6 (carboxymethylation level 80%), or carboxymethylated sodium fatty alcohol ethoxylates with e.g. R═C12C14 and n=4.5 (carboxymethylation level 94%) in relation to crude oil in salt water at temperatures of 46 to 85° C. The surfactant concentration used (>5 percent by weight) was very high in the flooding trials, which were conducted at <55° C. A polymer (polysaccharide) was used in the flooding trials.

U.S. Pat. No. 4,485,873 A1 describes the use of anionic surfactants of the type R—(OCH₂CH₂)ₙ-OCH₂COOM, which are based on an alkyl radical R having 4 to 20 carbon atoms or on an alkylated aromatic radical, the total number of the carbon atoms in the alkyl radicals being 1 to 28, in tertiary mineral oil production. With regard to the repeating units, n is a number from 1 to 30. The surfactants are produced via reaction of the corresponding alkoxylates with sodium chloroacetate and sodium hydroxide or aqueous soda lye. The carboxymethylation level may range from 10% to 100% (preferably 50-100%). The examples show only the use of carboxymethylated sodium nonylphenol ethoxylates with e.g. n=5.5 (carboxymethylation level 70%), or carboxymethylated sodium fatty alcohol ethoxylates with e.g. R═C12C14 and n=4.4 (carboxymethylation level 65%) in relation to model oil in salt water at temperatures of 37 to 74° C. The surfactant concentration used (>5 percent by weight) was very high in the flooding trials, which were conducted at ≤60° C. The polymer used in the flooding trials was hydroxyethylcellulose.

U.S. Pat. No. 4,542,790 A1 describes the use of anionic surfactants of the type R—(OCH₂CH₂)ₙ-OCH₂COOM, which are based on an alkyl radical R having 4 to 20 carbon atoms or an alkylated aromatic radical, the total number of the carbon atoms in the alkyl radicals being 1 to 28, in tertiary mineral oil production. With regard to the repeating units, n is a number from 1 to 30. The surfactants are produced via a reaction of the corresponding alkoxylates with sodium chloroacetate and sodium hydroxide or aqueous soda lye. The carboxymethylation level may range from 10% to 100%. The examples show the use of carboxymethylated sodium nonylphenol ethoxylates with e.g. n=5.3 (carboxymethylation level 76%) or carboxymethyated sodium C12C14 fatty alcohol ethoxylates in relation to low-viscosity crude oil (10 mPas at 20° C.) in salt water at temperatures of 46 to 85° C. The surfactant concentration used (2 percent by weight) in the flooding trials, which were conducted at ≤60° C., was relatively high. U.S. Pat. No. 4,811,788 A1 discloses the use of R—(OCH₂CH₂)ₙ—OCH₂COOM, which are based on the alkyl radical 2-hexyldecyl (derived from C16 Guerbet alcohol) and for which n is the number 0 or 1, in tertiary mineral oil production.

EP 0207312 B1 describes the use of anionic surfactants of the type R—(OCH₂C(CH₃)H)ₘ(OCH₂CH₂)ₙ—OCH₂COOM, which are based on an alkyl radical R having 6 to 20 carbon atoms or on an alkylated aromatic radical, the total number of the carbon atoms in the alkyl radicals being 5 to 40, in a blend with a more hydrophobic surfactant, in tertiary mineral oil production. With regard to the repeating units, m is a number from 1 to 20 and n is a number from 3 to 100. The surfactants are produced via a reaction of the corresponding alkoxylates with sodium chloroacetate and sodium hydroxide or aqueous soda lye. The carboxymethylation level may range from 10% to 100%. The examples show the use of carboxymethylated sodium dinonylphenol-block-propoxyoxethylate with m=3 and n=12 (carboxymethylation level 75%) together with alkylbenzenesulfonate and/or alkanesulfonate in relation to model oil in seawater at temperatures of 20 and 90° C. Deoiling at 90° C. in core flooding trials gave poorer values than at 20° C., and the surfactant concentration used (4 percent by weight) was very high.

WO 2009/100298 A1 describes the use of anionic surfactants of the type R¹—O—(CH₂C(CH₃)HO)ₘ(CH₂CH₂O)ₙ—XY⁻M⁺, which are based on a branched alkyl radical R¹ having 10 to 24 carbon atoms and on a degree of branching of 0.7 to 2.5, in tertiary mineral oil production. Y⁻ may represent, among other groups, a carboxylate group. In the examples for the alkyl ether carboxylates, R¹ is always a branched alkyl radical having 16 to 17 carbon atoms, and X is always a CH₂ group. With regard to the repeating units, examples are given with m=0 and n=9, with m=7 and n=2, and with m=3.3 and n=6. The surfactants are produced via a reaction of the corresponding alkoxylates with sodium chloroacetate and aqueous sodium hydroxide solution. The carboxymethylation level is disclosed as being 93% for the example with m=7 and n=2. In the examples, the alkyl ether carboxylates are tested as sole surfactants (0.2 percent by weight) in marine water at 72° C. in relation to crude oil. The interfacial tensions achieved were always above 0.1 mN/m.

WO 09124922 A1 describes the use of anionic surfactants of the type R¹—O—(CH₂C(R²)HO)_{n″}(CH₂CH₂O)ₘ—R⁵—COOM, which are based on a branched, saturated alkyl radical R¹ having 17 carbon atoms and a degree of branching of 2.8 to 3.7, in tertiary mineral oil production. R² is a hydrocarbyl radical having 1 to 10 carbon atoms. R⁵ is a divalent hydrocarbyl radical having 1 to 12 carbon atoms. Moreover, n″ is a number from 0 to 15 and m″ is a number from 1 to 20. The ways in which these anionic surfactants can be obtained include the oxidation of corresponding alkoxylates, in which case a terminal —CH₂CH₂OH group is converted into a terminal group —CH₂CO₂M.

WO 11110502 A1 describes the use of anionic surfactants of the type R¹—O—(CH₂C(CH₃)HO)ₘ(CH₂CH₂O)ₙ—XY⁻M⁺, which are based on a linear, saturated or unsaturated alkyl radical R¹ having 16 to 18 carbon atoms, in tertiary mineral oil production. Y⁻ may be a carboxylate group among other groups, and X may be an alkyl or alkylene group having up to 10 carbon atoms, among other groups. Moreover, m is a number from 0 to 99 and preferably is 3 to 20, and n is a number from 0 to 99. The ways in which these anionic surfactants can be obtained include the reaction of corresponding alkoxylates with sodium chloroacetate.

WO 2012/027757 A1 claims surfactants of the type R¹—O—(CH₂C(R²)HO)ₙ(CH(R³)_{z}—COOM and also their use in tertiary mineral oil production. R¹ stands for alkyl radicals and/or optionally substituted cycloalkyl and/or optionally substituted aryl radicals having in each case 8 to 150 carbon atoms. R² and R³ may each be H or alkyl radicals having 1 to 6 carbon atoms. The value n stands for a number from 2 to 210, and z for a number of 1-6. Examples given are only surfactant mixtures at least comprising a sulfonate-containing surfactant (e.g. internal olefin-sulfonates or alkylbenzenesulfonates) and an alkyl ether carboxylate, for which R¹ is a branched, saturated alkyl radical having 24 to 32 carbon atoms and is derived from Guerbet alcohols having only one branching point (in the 2-position). Said alkyl ether carboxylates have at least 25 repeating units for which R² is CH₃, and at least 10 repeating units for which R² is H, and so n is at least a number greater than 39. In all the examples, R³ is H and z is the number 1. The surfactant mixtures include at least 0.5 percent by weight of surfactant and are tested in relation to crude oils at temperatures of 30 to 105° C.

WO 2013/159027 A1 claims surfactants of the type R¹—O—(CH₂C(R²)HO)ₙ—X and also the use thereof in tertiary mineral oil production. R¹ stands for alkyl radicals having in each case 8 to 20 carbon atoms and/or for optionally substituted cycloalkyl and/or optionally substituted aryl radicals. R² may be H or CH₃, the value n stands for a number from 25 to 115. X is SO₃M, SO₃H, CH₂CO₂M or CH₂CO₂H (M¹ is a cation). Further disclosed are structures of the type R¹—O—(CH₂C(CH₃)HO)ₓ—(CH₂CH₂O)_{y}—X, where x is a number from 35 to 50 and y is a number from 5 to 35. As an example, the surfactant C₁₅H₃₅—O—(CH₂C(H₃)HO)₄₅—(CH₂CH₂O)₃₀—CH₂CO₂M (C₁₈H₃₅ stands for oleyl) is recovered in a blend with an internal C19-C28 olefinsulfonate and phenyldiethylene glycol. The surfactant mixtures include at least 1.0 percent by weight of surfactant and are tested in relation to crude oils at temperatures of 100° C. and at 32 500 ppm of total salinity, in the presence of sodium metaborate as base.

WO 2016/079121 A1 claims a surfactant mixture of R¹—O—(CH₂C(R²)HO)ₓ—(CH₂C(CH₃)HO)_{y}—(CH₂CH₂O)_{z}—CH₂CO₂M and R¹—O—(CH₂C(R²)HO)ₓ—(CH₂C(CH₃)HO)—(CH₂CH₂O)_{z}—H in a molar ratio of 51:49 to 92:8 and also the use thereof in tertiary mineral oil production in deposits at temperatures of 55° C. to 1500° C. R¹ stands for alkyl radicals having in each case 10 to 36 carbon atoms. Deposit conditions in the examples are 148 200 ppm TDS and 100° C.

DE3825585 describes, for a sandstone oil deposit with 56° C. and 220 000 ppm TDS, a surfactant mixture composed of the nonionic surfactant ethoxylated naphthol (C₁₀H₇O—(CH₂CH₂O)₁₅—H), the anionic surfactant alkylphenol ether sulfonate C₃H₇—C₆H₄O—(CH₂CH₂O)₁₂—(CH₂)₂SO₃Na and the cationic surfactant lauryl/myristylbenzyldimethylammonium chloride C₁₂H₂₅/C₁₄H₂₉N(CH₃)₂CH₂C₆H₅Cl. The cationic surfactant was used in a molar deficiency relative to the anionic surfactant (˜25 mol %:75 mol %). There was no description of oil/water interfacial tensions.

S. L. Wellington and E. A. Richardson (SPE 30748, SPE Journal, Volume 2, December 1997, 389-405) describe, for sandstone oil deposits at <95° C. and with synthetic seawater (35 000 ppm TDS), surfactant mixtures composed of the anionic surfactants C₈H₁₇O—(CH₂CH(CH₃)O)₇—CH₂CH(OH)CH₂—SO₃Na or C₉H₁₉/C₁₁H₂₃O—(CH₂CH(CH₃)O)₇—CH₂CH(OH)CH₂—SO₃Na or C₁₂H₂₅/C₁₃H₂₇/C₁₄H₂₉/C₁₅H₃₁O—(CH₂CH(CH₃)O)₇—(CH₂CH₂O)₂—CH₂CH(OH)CH₂—SO₃Na or C₁₂H₂₅/C₁₃H₂₇/C₁₄H₂₉/C₁₅H₃₁O—(CH₂CH(CH₃)O)₉—(CH₂CH₂O)₄—CH₂CH(OH)CH₂—SO₃Na or C₁₂H₂₅/C₁₃H₂₇/C₁₄H₂₉/C₁₅H₃₁O—(CH₂CH₂)₂—CH₂CH₂—SO₃Na with the cationic surfactants cocoalkylmethylbis(2-hydroxyethyl)ammonium chloride C₁₂H₂₅/C₁₄H₂₉N(CH₂CH₂OH)₂CH₃Cl or poly[oxy(methyl-1,2-ethanediyl)],α-[2-(diethylmethylammonio)methylethyl]-w-hydroxy-, chloride H₃C(C₂H₅)₂NCH₂CH₂O—(CH₂CH(CH₃)O)₈—HCl. The sum total of the cationic surfactants is used in a molar deficiency relative to the sum total of anionic surfactants (<23 mol %:>77 mol %). Oil-water interfacial tensions of 0.005 to 0.069 mN/m are described.

US 2011/0220364 describes, for sandstone oil deposits at <35° C. and with salinities of <25 000 ppm TDS, surfactant mixtures composed of the anionic surfactants (alkyl ether sulfates) C₁₆H₃₃/C₁₈H₃₇O—(CH₂CH(CH₃)O)₆—SO₃Na or C₁₆H₃₇O/C₁₈H₃₇O—(CH₂CH(CH₃)O)₈—SO₃Na with the cationic surfactants C₈H₁₇N[CH₂CH₂OH]₂CH₃OSO₃CH₃ or C₈H₁₇N[(CH₂CH₂O)_{1.5}CH₂CH₂OH]₂CH₃OSO₃CH₃. The cationic surfactant is used in a molar deficiency relative to the anionic surfactant (<36 mol %:>64 mol %). Oil-water interfacial tensions of 0.002 to 0.017 mN/m are described.

CN104099077 claims, for flooding operations in oil deposits with 32 000 to 360 000 ppm TDS, surfactant mixtures comprising at least one non-amphoteric surfactant. The surfactant mixtures may also comprise an amphoteric surfactant. Non-amphoteric surfactants mentioned are alkyl ethoxylates, sulfated alkyl ethoxylates, nonylphenol ether sulfonates, fatty amine ether sulfonates, and alkyl ether bismethylenecarboxylates, each without any more specific description of the structure. Amphoteric surfactants mentioned are alkylamidobetaines and alkyl betaines, each without any more specific description of the structure. The examples involve sandstone oil deposits.

CN103409123 describes, for oil deposits at 55° C. and having salinities of −4000 ppm TDS, a surfactant mixture composed of the general betaine surfactant alkylamidopropyldimethylbetaine and the general anionic surfactant alkylbenzenesulfonate. Oil-water interfacial tensions of 0.008 mN/m are described.

WO 95/14658 A1 describes low-viscosity aqueous concentrates of betaine surfactants. CN 103421480 describes a surfactant composition comprising a cationic surfactant and an anionic-nonionic surfactant.

US 2016/0122621 describes, for flooding operations in oil deposits, surfactant mixtures composed of an anionic surfactant additionally comprising nonionic groups, and a cationic surfactant. The molar mixing ratio of anionic surfactant to cationic surfactant is to range from 100:1 to 1:100. In the examples, for an oil deposit of sandstone at 81° C. with about 8000 ppm TDS, the surfactant mixture composed of the anionic surfactant C₂₀H₄₁O—(CH₂C₂CH(CH₃)O)₂₃—(CH₂CH₂O)₈₂—CH₂CH₂CO₂K and the cationic surfactant decyltriethylammonium hydroxide C₁₀H₂₁N(CH₂CH₃)₃OH is used. The cationic surfactant is used in molar deficiency relative to the anionic surfactant (13 mol %:87 mol %). An oil-water interfacial tension of 0.006 mN/m is described for this.

G. J. Hirasaki et al. (SPE 169051, SPE Journal, Volume 21, August 2016, 1164-1177) describes, for an oil deposit of sandstone at 76° C. and with 5000 ppm TDS, a general surfactant mixture composed of anionic nonylphenol ethoxycarboxylate surfactant and cationic quaternary ammonium salt surfactant, without further disclosure of any structural details. The cationic surfactant is used in molar deficiency relative to the anionic surfactant (40 mol %:60 mol %). Oil-water interfacial tensions of 0.0001 to 0.001 mN/m are described.

G. J. Hirasaki et al. (Journal of Surfactants and Detergents, Volume 20, Issue 1, pages 21-34, January 2017) describes, for oil deposits of sandstone or carbonate each at 80° C. and with about 1600 ppm TDS, a surfactant mixture composed of anionic nonylphenol ethoxycarboxylate surfactant and cationic octadecyltrimethylammonium chloride surfactant C₁₈H₃₇N(CH₃)₃Cl. In the case of the sandstone deposit, the cationic surfactant is used in molar deficiency or in an equimolar amount relative to the anionic surfactant (40 mol %:60 mol % or 50 mol %:50 mol %). Oil-water interfacial tension of 0.001 mN/m is described in the case of the sandstone deposit (on the basis of the Huh equation and the solubilization parameter SP* measured in the respective case). In the case of the carbonate deposit, the cationic surfactant is used in a slight molar excess relative to the anionic surfactant (57 mol %:43 mol %): the surfactant solution has clear solubility, but no desirable middle phase forms (and hence no Winsor type III microemulsion).

G. J. Hirasaki et al. (Journal of Colloid and Interface Science 2013, 408, 164-172 and Langmuir 2016, 32 (40), 10244-10252) describe static adsorption tests of different surfactants on carbonate rock or sandstone. The salinities used are very low. In some cases, testing was effected in demineralized water or with salinities of about 30 270 ppm TDS.

In spite of the surfactants and surfactant mixtures known in the prior art, there is a need for improved surfactant mixtures, especially for use in methods of mineral oil production in mineral oil deposits having high temperatures and high salinities. At the same time, both the solubility and the properties for lowering interfacial tension are to be improved.

It is therefore an object of the present invention to provide such a method.

The object is achieved by a method of producing mineral oil from underground mineral oil deposits, in which an aqueous saline surfactant formulation comprising a surfactant mixture, for the purpose of lowering the interfacial tension between oil and water to <0.1 mN/m, is injected into a mineral oil deposit through at least one injection well and crude oil is withdrawn from the deposit through at least one production well, wherein

the mineral oil deposit has a temperature of ≥90° C. and a formation water having a salinity of ≥30 000 ppm of dissolved salts

and the surfactant mixture comprises at least one ionic surfactant (A) of the general formula (I)

(R¹)ₖ—N⁺(R²)₍₃₋ₖ₎R³(X⁻)ₗ (I)

and at least one anionic surfactant (B) of the general formula (II)

R⁴—O—(CH₂C(R⁵)HO)ₘ—(CH₂C(CH₂C)HO)ₙ—(CH₃)HO)₂CH₂O)ₒ—(CH₂)ₚ—Y⁻M⁺ (II)

with a molar ratio of ionic surfactant (A) to anionic surfactant (B) in the surfactant mixture on injection of 90:10 to 10:90,

where

each R¹ is independently a linear or branched, saturated or unsaturated, aliphatic hydrocarbyl radical having 8 to 22 carbon atoms or is the R⁴—O—(CH₂C(R)HO)ₘ—(CH₂C(CH₃)HO)ₙ—(CH₂CH₂O)ₒ—(CH₂CH₂)— or R⁴—O—(CH₂C(R⁵)HO)ₘ—(CH₂C(CH₃)HO)ₙ—(CH₂CH₂O)ₒ—(CH₂C(CH₃)H)— radical;

each R² is CH₃;

R³ is CH₃ or (CH₂CO₂)⁻;

each R⁴ is independently a linear or branched, saturated or unsaturated, aliphatic hydrocarbyl radical having 8 to 36 carbon atoms or an aromatic or aromatic-aliphatic hydrocarbyl radical having 8 to 36 carbon atoms;

each R⁵ is independently a linear or branched, saturated or unsaturated, aliphatic hydrocarbyl radical having 2 to 16 carbon atoms or an aromatic or aromatic-aliphatic hydrocarbyl radical having 6 to 10 carbon atoms;

X is Cl, Br, I or H₃CO—SO₃;

Y is CO₂ or SO₃;

M is Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H₅)₃H or NH₄;

k is the number 1 or 2,

l is the number 0 or 1;

each m is independently a number from 0 to 15;

each n is independently a number from 0 to 50;

each o is independently a number from 1 to 60;

each p is independently a number from 1 to 4;

where

the sum total of n+o is a number from 7 to 80;

p is the number 1 if Y is CO₂;

p is the number 2, 3 or 4 if Y is SO₃;

l is the number 0 if R³ is (CH₂CO₂)⁻ or is 1 if R³ is CH₃.

A surfactant mixture as described above surprisingly exhibits very good thermal stability and can therefore be used in the method of the invention.

Surprisingly it is possible to achieve particularly good properties under very difficult conditions (temperature of >90° C. and formation water with a salinity of >210 000 ppm of dissolved salts) if use is made additionally of what are called hydrotropes, of the formula (III), as described below. In this case it is possible to achieve sufficient solubility of the surfactants in the deposit water and at the same time to bring about the formation of a Winsor type III microemulsion in the presence of crude oil. A further surprise is that hydrotropes such as cumenesulfonate, for example, are not active, by comparison with hydrotropes of the formula (III).

Especially cationic surfactants having a different structure than those of the anionic surfactants (A) of the general formula (I) exhibit a significantly high degradation rate in the course of storage at high temperature. Ionic surfactants (A) of the general formula (I), by contrast, are surprisingly stable to degradation at high temperature. Astonishingly, the surfactants are thermally stable in the surfactant mixture of the method of the invention if the 1-hydrogen atom is within the hydrophobic moiety of the surfactant. Anionic surfactants (B) of the general formula (II) are thermally stable. Equally, hydrotropes (C) of the general formula (III) are thermally stable. In addition, solubility and salt tolerance are very good. This is even true under extremely demanding conditions if a molar excess of ionic surfactant (A) over the anionic surfactant (B) is used: temperatures of 120° C. at a salinity of 130 000 or 240 000 ppm TDS (water is simultaneously rich in calcium or magnesium ions). On contact of the surfactant mixtures claimed with crude oil, this does not just result in a low interfacial tension with respect to crude oil; the formation of a Winsor type III microemulsion is actually observed. This is also the case with a different oil/water ratio.

Surfactant mixtures having a molar excess of ionic surfactant (A) of the general formula (I) over anionic surfactant (B) of the general formula (II) are suitable for deposits of carbonate rock (preferably slightly negatively charged or uncharged carbonate rock having a zeta potential of −4 to 0 mV and more preferably positively charged carbonate rock having a zeta potential of >0 mV). Surfactant mixtures having a molar deficiency of ionic surfactant (A) of the general formula (I) compared to anionic surfactant (B) of the general formula (II) are suitable for deposits of sandstone or negatively charged carbonate rock. These deposits of sandstone or negatively charged carbonate rock preferably have salinities of <100 000 ppm TDS at temperatures of 90° C. or more.

It has also been found, inter alia, that the surfactant mixture of the surfactants of the formulae (I) and (II) have improved properties compared to the individual surfactants, and that these are more suitable than other surfactants on the basis of their chemical structure. Without being bound to any theory, the surfactants of the formulae (I) and (II)—as described herein—have higher stability compared to other surfactants.

Surfactants having sulfate groups, for example, have a stronger tendency to hydrolysis. The same applies to surfactants containing ester groups. It is likewise possible for amide groups having a low degree of substitution to undergo hydrolysis. Quaternary ammonium compounds having β-hydrogen atoms to the ammonium group can be cleaved via Hofmann degradation. Finally, ether carboxylates having a CH₂CH₂ spacer between the carboxylate group and oxygen of the ether function can be cleaved to acrylic acid and alcohol in a kind of retro-Michael addition.

In the method of the invention, the surfactant mixture includes at least one surfactant (A) of the general formula (I) and at least one surfactant (B) of the general formula (II) and also preferably at least one hydrotrope (C) of the general formula (III). On injection, i.e. at the juncture at which the surfactant mixture forms the aqueous saline surfactant formulation together with the injection water, and this is injected into the earth, the molar ratio of surfactant (A) to surfactant (B) is 90:10 to 10:90. Correspondingly, the surfactant formulation comprises at least the surfactant mixture and water, and optionally further salts, especially those present in saline water such as seawater, and optionally at least one hydrotrope (C).

Accordingly, the aqueous saline surfactant formulation is understood to mean a surfactant mixture, optionally with at least one hydrotrope, which is dissolved in saline water (for example during the injection operation). The saline water may, inter alia, be river water, seawater, water from an aquifer close to the deposit, what is called injection water, deposit water, what is called production water which is being reinjected, or mixtures of the types of water described above.

Alternatively, the water may be saline water which has been obtained from a water richer in salt: for example partial desalination, depletion of the polyvalent cations, or by dilution with freshwater or drinking water. The surfactant mixture may preferably be provided as a concentrate which, as a result of the production, may also comprise salt. This is set out in detail in the paragraphs which follow.

Preferably, on injection of the surfactant mixture, there is a molar ratio of ionic surfactant (A) to anionic surfactant (B) of 85:15 to 35:65, preferably 80:20 to 55:45, more preferably 79:21 to 58:42.

The surfactant mixture in the method of the invention includes at least one ionic surfactant (A) of the general formula (I)

(R¹)ₖ—N⁺(R²)₍₃₋ₖ₎R³(X⁻)ₗ (I).

Accordingly, one ionic surfactant (A) or a plurality of ionic surfactants (A), such as two, three or more ionic surfactants (A), may be present.

The R¹ radical here is a linear or branched, saturated or unsaturated, aliphatic hydrocarbyl radical having 8 to 22 carbon atoms or the R⁴—O—(CH₂C(R⁵)HO)ₘ—(CH₂C(CH₃)HO)ₙ—(CH₂CH₂O)ₒ—(CH₂CH₂)— or R⁴—O—(CH₂C(R)HO)ₘ—(CH₂C(CH₃)HO)ₙ—(CH₂CH₂O)ₒ—(CH₂C(CH₃)H)— radical.

If two or more surfactants (A) are present in the surfactant mixture, these may differ, for example, at least in the R¹ radical and are accordingly selected independently. However, the R¹ radicals may be the same for different surfactants (A), such that these differ in some other way.

If R¹ is the R⁴—O—(CH₂C(R⁵)HO)ₘ—(CH₂C(CH₃)HO)ₙ—(CH₂CH₂O)ₒ—(CH₂CH₂)— or R⁴—O—(CH₂C(R)HO)ₘ—(CH₂C(CH₃)HO)ₙ—(CH₂CH₂O)ₒ—(CH₂C(CH₃)H)— radical, R⁴, R⁵, m, n, o are selected as for the same radicals or variables from the same definitions as for formula (II), where the variables for formula (I) and formula (II) may be the same or different. Preferably, however, the R¹ radical is a linear or branched, saturated or unsaturated, aliphatic hydrocarbyl radical having 8 to 22 carbon atoms.

Preferably, R¹ is a linear or branched, saturated or unsaturated, aliphatic hydrocarbyl radical having 12 to 18 carbon atoms, more preferably a linear aliphatic hydrocarbyl radical having 12 to 18 carbon atoms, more preferably a linear aliphatic hydrocarbyl radical having 12 to 16 carbon atoms.

Illustrative radicals are linear saturated C₈H₁₇—, C₉H₁₉—, C₁₀H₂₁—, C₁₁H₂₃—, C₁₂H₂₅—, C₁₃H₂₇—, C₁₄H₂₉, C₁₅H₃₁—, C₁₆H₃₃—, C₁₇H₃₅—, C₁₈H₃₇—, C₁₉H₃₉—, C₂₀H₄₁—, C₂₁H₄₃— and C₂₂H₄₅— radicals. If two or more surfactants (A) are present, it is possible, for example, for mixtures of two, three or more surfactants (A) with these radicals, for example a mixture of surfactants (A) having C₁₂H₂₅— and C₁₄H₂₉— radicals to be present.

The variable k in the formula (I) indicates the frequency of R¹ in a surfactant (A). This is 1 or 2, preferably 1. If it is 2, however, the two R¹ radicals may be the same or different, preferably the same. The R² radical is a methyl radical, where this occurs 3-k times, i.e. twice or once. The R³ radical is CH₃ or (CH₂CO₂)⁻, i.e. a carboxylatomethyl radical.

The anionic surfactant (A) may take the form of an internal (I=0, R³═(CH₂CO₂)⁻) or external salt (I=1, R³═CH₃), where positive and negative charges balance out. The counterions X⁻ are Cl⁻, Br⁻, I⁻ or H₃CO—SO₃⁻ (monomethyl ester sulfate), preferably Cl⁻ or H₃CO—SO₃, more preferably chloride.

The anionic surfactant (A) of the surfactant mixture in the method of the invention is in undissolved, partly dissolved or fully dissolved form in the aqueous saline surfactant formulation, preferably in fully dissolved form.

Ionic surfactants (A) are either commercially available or can be prepared by known methods that are known to the competent person of average skill in the art.

The surfactant mixture in the method of the invention further comprises at least one anionic surfactant (B) of the formula (II)

R⁴—O—(CH₂C(R⁵)HO)ₘ—(CH₂C(CH₃)HO)ₙ—(CH₂CH₂O)ₒ—(CH₂)ₚ—Y⁻M⁺ (II).

Accordingly, one anionic surfactant (B) or a plurality of anionic surfactants (B), such as two, three or more anionic surfactants (B), may be present.

The R⁴ radical here is a linear or branched, saturated or unsaturated, aliphatic hydrocarbyl radical having 8 to 36 carbon atoms or an aromatic or aromatic-aliphatic hydrocarbyl radical having 8 to 36 carbon atoms.

If two or more surfactants (B) are present in the surfactant mixture, these may differ, for example, at least in the R⁴ radical and are accordingly selected independently. However, the R⁴ radicals may be the same for different surfactants (B), such that these differ in some other way.

It is likewise possible for identical or different R⁴ radicals to occur for one or more surfactants (A) and one or more surfactants (B) if, in surfactant (A), R¹ is the R⁴—O—(CH₂C(R⁵)HO)ₘ—(CH₂C(CH₃)HO)ₙ—(CH₂CH₂O)ₒ—(CH₂CH₂)— or R⁴—O—(CH₂C(R⁵)HO)ₘ—(CH₂C(CH₃)HO)ₙ—(CH₂CH₂O)ₒ—(CH₂C(CH₃)H)— radical.

The terms “aliphatic” and “aromatic” have the definition known to the person skilled in the art. It is a feature of aromatic aliphatic hydrocarbyl radicals that they have both an aromatic radical and an aliphatic radical. The simplest example would be a benzyl radical. Examples of aromatic-aliphatic hydrocarbyl radicals having 8 carbon atoms are phenylethyl, methylphenylmethyl and dimethylphenyl.

Preferably, the R⁴ radical is a linear or branched, saturated or unsaturated, aliphatic hydrocarbyl radical having 12 to 30, more preferably 13 to 19, carbon atoms.

The R⁴ radical of the at least one surfactant (B) may have a degree of branching of 0, 1, 2, 3 or 4, preferably 0 or 1. If two or more surfactants (B) having different R⁴ radicals occur, these may additionally or alternatively satisfy the condition that the mean degree of branching has a value of 0 to 4, preferably 0 to 3.5, more preferably of 0 to 1.

The degree of branching of a radical results from the branches in the carbon skeleton. For any radical, it is defined as the number of carbon atoms bonded to 3 further carbon atoms plus twice the number of carbon atoms bonded to four further carbon atoms. The mean degree of branching of a mixture results from the sum total of all degrees of branching of the individual molecules divided by the number of individual molecules. The degree of branching is determined, for example, by NMR methods. This can be done via analysis of the carbon skeleton with suitable coupling methods (COSY, DEPT, INADEQUATE), followed by quantification via ¹³C NMR with relaxation reagents. However, other NMR methods or GC-MS methods are also possible.

Illustrative radicals are those radicals that are derived from the following alcohols: linear saturated primary alcohols of the formula C₁₆H₃₃OH or C₁₈H₃₇OH, saturated primary alcohols having a branch in the 2 position (degree of branching=1) of the formula C₂₄H₄₉OH, C₂₅H₅₃OH or C₂₈H₅₇OH. If two or more surfactants (B) are present, there may, for example, be mixtures of two, three or more surfactants (B) having these radicals, for example a mixture of surfactants (B) with linear saturated primary alcohols of the formula C₁₆H₃₃OH and C₁₈H₃₇OH, as present in commercially available tallow fatty alcohol mixtures. A further example is a Guerbet alcohol mixture consisting of saturated primary alcohols with the branching in the 2 position: C₂₄H₄₉—OH, C₂₆H₅₃—OH and C₂₈H₅₇—OH; prepared by condensation reaction of linear C₁₂C₄ fatty alcohol as described, for example, in WO 2013/060670 A1.

The R⁵ radical is a linear or branched, saturated or unsaturated, aliphatic hydrocarbyl radical having 2 to 16 carbon atoms or an aromatic or aromatic aliphatic hydrocarbyl radical having 6 to 10 carbon atoms.

If two or more surfactants (B) are present in the surfactant mixture, these may differ, for example, at least in the R⁵ radical and are accordingly selected independently. However, the R⁵ radicals may be the same for different surfactants (B), such that these differ in some other way. It is likewise possible for identical or different R⁵ radicals to occur for one or more surfactants (A) and one or more surfactants (B) if, in surfactant (A), R′ is the R⁴—O—(CH₂C(R⁵)HO)ₘ—(CH₂C(CH₃)HO)—(CH₂CH₂CH₂O)ₒ—(CH₂CH₂)— or R⁴—O—(CH₂C(R⁵)HO)ₘ—(CH₂C(H₂C(CH₃)HO)ₙ—(CH₂CH₂O)ₒ—(CH₂C(CH₃)H)— radical.

Preferably, the R⁵ radical is a saturated hydrocarbyl radical having 2 to 14 carbon atoms. More particularly, R^{S} is a radical having 2 carbon atoms and hence ethyl, such that the higher alkyleneoxy group is 2-butyleneoxy.

The higher alkyleneoxy groups including R⁵ occur m times. m here is a number from 0 to 15. Preferably, m=0 (higher alkylene group is absent). If two or more surfactants (B) are present in the surfactant mixture, these may differ, for example, at least in the number m and are accordingly selected independently. However, the numbers m may be the same for different surfactants (B), such that these differ in some other way. It is likewise possible for different or identical numbers m to occur for one or more surfactants (A) and one or more surfactants (B) if, in surfactant (A), R¹ is the R⁴—O—(CH₂C(R⁵)HO)ₘ—(CH₂C(CH₃)HO)ₙ—(CH₂CH₂)ₒ—(CH₂CH₂)— or R⁴—O—(CH₂C(R⁵)HO)ₘ—(CH₂C(CH₃)HO)ₙ—(CH₂CH₂O)ₒ—(CH₂C(CH₃)H)— radical. If two or more surfactants (B)/(A) occur, the number m can also assume an average number. This average number may additionally or alternatively, preferably additionally, satisfy the above-specified value ranges.

In addition, propyleneoxy groups can occur n times. n here is a number from 0 to 50. Preferably, n=0 to 30, more preferably 0 to 15 or 5 to 20, even more preferably 7 to 15, and even more preferably n=0 (propyleneoxy group is absent). If two or more surfactants (B) are present in the surfactant mixture, these may differ, for example, at least in the number n and are accordingly selected independently. However, the numbers n may be the same for different surfactants (B), such that these differ in some other way. It is likewise possible for different or identical numbers n to occur for one or more surfactants (A) and one or more surfactants (B) if, in surfactant (A), R¹ is the R⁴—O—(CH₂C(R⁵)HO)ₘ—(CH₂C(CH₃)HO)ₙ—(CH₂CH₂)ₒ—(CH₂CH₂)— or R⁴—O—(CH₂C(R⁵)HO)ₘ—(CH₂C(CH₃)HO)ₙ—(CH₂CH₂O)ₒ—(CH₂C(CH₃)H)— radical. If two or more surfactants (B6)/(A) occur, the number n can also assume an average number. This average number may additionally or alternatively, preferably additionally, satisfy the above-specified value ranges.

In addition, ethyleneoxy groups occur o times. o here is a number from 1 to 60. Preferably, o=3 to 50, more preferably 5 to 35, even more preferably 10 to 25. If two or more surfactants (B) are present in the surfactant mixture, these may differ, for example, at least in the number o and are accordingly selected independently. However, the numbers o may be the same for different surfactants (B), such that these differ in some other way. It is likewise possible for different or identical numbers o to occur for one or more surfactants (A) and one or more surfactants (B) if, in surfactant (A), R¹ is the R⁴—O—(CH₂C(R⁵)HO)ₘ—(CH₂C(CH₃)HO)ₙ—(CH₂CH₂O)ₒ—(CH₂CH₂)— or R⁴—O—(CH₂C(R⁵)HO)ₘ—(CH₂C(CH₃)HO)ₙ—(CH₂CH₂O)ₒ—(CH₂C(CH₃)H)— radical. If two or more surfactants (B)/(A) occur, the number o may also assume an average number. This average number may additionally or alternatively, preferably additionally, satisfy the above-specified value ranges.

The sum total of the variables n and o (n+o) gives a number from 7 to 80. Preferably, the sum total of n+o=7 to 50, more preferably 7 to 45, even more preferably 7 to 35, even more preferably 7 to 25.

In the case of presence of surfactant mixtures comprising two or more surfactants (B)/(A) of the general formula (II)/(I), the numbers m, n and o, as already set out above, are mean values across all molecules of the surfactants. Especially in the case of alkoxylation of alcohol with ethylene oxide or propylene oxide or higher alkylene oxides (e.g. butylene oxide), a certain distribution of chain lengths is typically obtained in each case. This distribution can, in a manner known in principle, be described by what is called the polydispersity D. D=M_{w}/Mₙ is the quotient of the weight-average molar mass and the number-average molar mass. Polydispersity can be ascertained by means of the methods known to those skilled in the art, for example by means of gel permeation chromatography. If a single formula is stated for a surfactant, without more specific details, this is the most commonly occurring compound in the mixture.

In the case of the presence of at least one hydrotrope (C), the number q, as already observed above, may be mean values across all the molecules. Especially in the case of the alkoxylation of alcohol with ethylene oxide, a certain distribution of chain lengths is typically obtained. This distribution can, in a manner known in principle, be described by what is called the polydispersity D. D=M_{w}/Mₙ is the quotient of the weight-average molar mass and the number-average molar mass. Polydispersity can be ascertained by means of the methods known to those skilled in the art, for example by means of gel permeation chromatography. If a single formula is stated for a hydrotrope, without more specific details, this is the most commonly occurring compound in the mixture. In a further embodiment of the invention, in respect of the degree of ethoxylation, the compound is a monodisperse compound, since the ethoxylated alcohol has been subjected to fractional distillation, and pure distillation fractions have been used for the further functionalization.

Higher alkyleneoxy (AO), propyleneoxy (PO) and ethyleneoxy (EO) groups may be in random distribution or arranged alternately or in blocks if at least one variable m or n is not zero. There is preferably a blockwise arrangement.

The alkyleneoxy groups may thus be randomly distributed or arranged alternately or in blocks, i.e. in two, three, four or more blocks.

Preferably, the m (higher alkyleneoxy), n propyleneoxy and o ethyleneoxy groups are at least partly arranged in blocks (preferably, in numerical terms, to an extent of at least 50%, more preferably to an extent of at least 60%, even more preferably to an extent of at least 70%, more preferably to an extent of at least 80%, more preferably to an extent of at least 90%, especially completely).

In the context of the present invention, “arranged in blocks” means that at least one alkyleneoxy has an adjacent alkyleneoxy group which is chemically identical, such that these at least two alkyleneoxy units form a block.

More preferably, the R¹—O radical is followed by a (higher alkylene)oxy block having m (higher alkylene)oxy groups followed by a propyleneoxy block having n propyleneoxy groups and finally an ethyleneoxy block having o ethyleneoxy groups.

The variable p is the number 1 if Y is CO₂. Otherwise, p is the number 2, 3 or 4 (preferably 2) if Y is SO₃. Accordingly, either carboxylates or sulfonates occur. If two or more surfactants (B) are present in the surfactant mixture, these may differ, for example, at least in the number p and are accordingly selected independently. However, the numbers p may be the same for different surfactants (B), such that these differ in some other way.

Counterions M that may occur include cations selected from the group consisting of Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H₅)₃H and NH₄. The cation M balances out the negative charge of the carboxylate or sulfonate anion. Preference is given to the sodium cation. If two or more surfactants (B) are present in the surfactant mixture, these may differ, for example, at least in M. However, this is not preferred.

The surfactants (B) can be prepared by processes known to those skilled in the art. Reference is made here by way of example to WO 2016/079121 A1.

The surfactant formulation preferably comprises at least one anionic hydrotrope (C) of the general formula (III)

R⁶—O—(CH₂CH₂O)_{q}—CH₂CO₂⁻M⁺ (III),

where R⁶ is a linear or branched, saturated aliphatic hydrocarbyl radical having 1 to 5 carbon atoms or is a phenyl radical, M has the definition of M for formula (II) and is selected independently thereof, and q is a number from 1 to 9.

Preferably R⁶ is a methyl, ethyl, n-propyl, isopropyl, n-butyl, isobutyl, n-pentyl, isopentyl or phenyl radical. More preferably it is a methyl, n-propyl or n-butyl radical. Very preferably it is an n-butyl radical.

M, corresponding to the definition for formula (II), comprises Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H₅)₃H or NH₄. Preferably it is Na or K and more preferably it is Na. For formula (II) and (III), M may be the same or different; preferably these are the same.

Preferably q is a number from 1 to 4 and more preferably it is a number from 1 to 2.

The ratio of hydrotrope (C) of the general formula (III) to the surfactant mixture which consists at least of the surfactant (A) of the general formula (I) and at least of the surfactant (B) of the general formula (II), on a weight basis, is preferably not more than 3:1 to 1:9. A range from 2:1 to 1:5 is preferred. Especially preferred is a range from 1:1 to 1:2.

The at least one anionic hydrotrope (C) may be prepared by processes known to those skilled in the art. This may be accomplished, for example, through reaction of alkyl ethoxylates or phenyl ethoxylates with NaOH and ClCH₂CO₂Na and/or NaOH and ClCH₂CO₂H. Another possibility is the oxidation of alkyl ethoxylates or phenyl ethoxylates with atmospheric oxygen (using a noble metal catalyst) to give the corresponding carboxylic acid, with subsequent neturalization with NaOH. Reference is also made here by way of example to WO 2016/079121 A1.

The method of the invention serves for production of mineral oil from underground mineral oil deposits, in which an aqueous saline surfactant formulation comprising a surfactant mixture, for the purpose of lowering the interfacial tension between oil and water to <0.1 mN/m, is injected into a mineral oil deposit through at least one injection well and crude oil is withdrawn from the deposit through at least one production well, wherein the mineral oil deposit has a temperature of >90° C. and a formation water having a salinity of ≥30 000 ppm or even >210 000 ppm (weight fraction based on the total weight) of dissolved salts (TDS).

The at least one anionic hydrotrope (C) may therefore be present in the formulation. Particularly if it is present, the formulation is suitable for extremely high salinities of >210 000 ppm TDS.

For the determination of the mineral oil deposit temperature, for example, wellbore measurements are conducted in which a thermometer suspended on a cable is dropped into the wells and the temperature of the oil carrier is measured at two or more depths. These are used to determine the average temperature that constitutes the mineral oil deposit temperature.

Measurements of mineral oil deposit temperature frequently proceed with use of optical fibers (see also http://petrowiki.org/Reservoirtemperature#Measurement_of_pressure_and_temperature).

Salinity can be determined via inductively coupled plasma mass spectrometry (ICP-MS).

In a further-preferred execution of the invention, a thickening polymer from the group of the biopolymers or from the group of the acrylamide-based copolymers is added to the aqueous saline surfactant formulation. The copolymer may consist, for example, inter alia, of the following units:
acrylamide and acrylic acid sodium salt
acrylamide and acrylic acid sodium salt and N-vinylpyrrolidone
acrylamide and acrylic acid sodium salt and AMPS (2-acrylamido-2-methylpropane-sulfonic acid sodium salt)
acrylamide and acrylic acid sodium salt and AMPS (2-acrylamido-2-methylpropane-sulfonic acid sodium salt) and N-vinylpyrrolidone

Particular preference is given to the copolymer formed from acrylamide and acrylic acid sodium salt and AMPS (2-acrylamido-2-methylpropanesulfonic acid sodium salt) and N-vinylpyrrolidone. The copolymer may also comprise additional groups.

A particularly preferred execution involves Winsor type III microemulsion polymer flooding.

For stabilization of the polymers, it is possible to add further additives such as biocides, stabilizers, free-radical scavengers and inhibitors.

Rather than or in addition to the addition of a polymer, it is also possible to add a foam for the purpose of mobility control. The foam can be generated at the deposit surface or in situ in the deposit by injection of gases such as nitrogen or gaseous hydrocarbons such as methane, ethane or propane. The gaseous hydrocarbons may also be mixtures comprising methane, ethane or propane. For generation and stabilization of the foam, the claimed surfactant mixture or else further surfactants can be added.

Optionally, it is also possible to add a base such as alkali metal hydroxide or alkali metal carbonate to the surfactant formulation, in which case it is combined with complexing agents or polyacrylates in order to prevent precipitation resulting from the presence of polyvalent cations.

In addition, it is also possible to add a cosolvent to the formulation.

This gives rise to the following (combined) processes:
surfactant flooding
Winsor type III microemulsion flooding
surfactant/polymer flooding
Winsor type III microemulsion/polymer flooding
alkali/surfactant/polymer flooding
alkali/Winsor type III microemulsion/polymer flooding
surfactant/foam flooding
Winsor type III microemulsion/foam flooding
alkali/surfactant/foam flooding
alkali/Winsor type III microemulsion/foam flooding

In a preferred embodiment of the invention, one of the first four methods is employed (surfactant flooding, Winsor type III microemulsion flooding, surfactant/polymer flooding or Winsor type III microemulsion/polymer flooding). Particular preference is given to Winsor type III microemulsion/polymer flooding.

In the case of Winsor type III microemulsion/polymer flooding, in the first step, a surfactant formulation with or without polymer is injected. On contact with crude oil, the surfactant formulation brings about the formation of a Winsor type III microemulsion. In the second step, polymer only is injected. In the first step in each case, it is possible to use aqueous formulations having higher salinity than in the second step. Alternatively, the two steps can also be conducted with water of the same salinity. In the first step, it is also possible to conduct operation in gradient mode in the surfactant mixture. This is to be elucidated by way of an example. Under deposit conditions, for example, a surfactant mixture comprising 65 mol % of ionic surfactant (A) of the general formula (I) to 35 mol % of anionic surfactant (B) of the general formula (II) forms a Winsor type III microemulsion with the crude oil. The injection water corresponds to the formation water in terms of its salinity. Injection is commenced firstly with a surfactant mixture of 55 mol % of ionic surfactant (A) of the general formula (I) to 45 mol % of anionic surfactant (B) of the general formula (II). Over the course of the injection, the relative ratio is adjusted such that 65 mol % of ionic surfactant (A) of the general formula (I) to 35 mol % of anionic surfactant (B) of the general formula (II) is attained. Thereafter, the injection is continued, with ultimate alteration of the surfactant ratio to 75 mol % of ionic surfactant (A) of the general formula (I) to 25 mol % of anionic surfactant (B) of the general formula (II) by continuing to alter the surfactant ratio stepwise. This method can optionally be conducted in the presence of other surfactants, polymer and/or foam and of other additives described above.

In one embodiment, the processes can of course also be combined with water flooding. In the case of water flooding, water is injected into a mineral oil deposit through at least one injection well and crude oil is withdrawn from the deposit through at least one production well. The water may be freshwater or saline water such as seawater or deposit water. After the water flooding, the method of the invention can be employed.

For execution of the method of the invention, at least one production well and at least one injection well are sunk into the mineral oil deposit. In general, a deposit is provided with multiple injection wells and multiple production wells. Vertical and/or horizontal wells may be present. An aqueous formulation of the water-soluble components described is injected into the mineral oil deposit through the at least one injection well, and crude oil is withdrawn from the deposit through at least one production well. The pressure generated by the aqueous formulation injected, called the “flood”, causes the mineral oil to flow in the direction of the production well, and it is produced by the production well. The term “mineral oil” in this connection does not of course just mean single-phase oil; instead, the term also encompasses the standard crude oil/water emulsions. It will be clear to the person skilled in the art that a mineral oil deposit can also have a certain temperature distribution. The deposit temperature mentioned relates to the region of the deposit between the injection wells and production wells that is covered by the flooding with aqueous solutions. Methods of ascertaining the temperature distribution of a mineral oil deposit are known in principle to those skilled in the art. The temperature distribution is generally determined from temperature measurements at particular points in the formation in combination with simulation calculations, where the simulation calculations also take account of amounts of heat introduced into the formation and the amounts of heat removed from the formation.

The method of the invention may especially be employed in the case of mineral oil deposits having an average porosity of 1 mD to 4 D, preferably 2 mD to 2 D and more preferably 5 mD to 500 mD. The permeability of a mineral oil formation is stated by the person skilled in the art in the unit “darcy” (abbreviated to “D” or “mD” for “millidarcies”) and can be determined from the flow rate of a liquid phase in the mineral oil formation as a function of the pressure differential applied. The flow rate can be determined in core flooding tests with drill cores taken from the formation. Details of this can be found, for example, in K. Weggen, G. Pusch, H. Rischmuller in “Oil and Gas”, pages 37 ff., Ullmann's Encyclopedia of Industrial Chemistry, online edition, Wiley-VCH, Weinheim 2010. It will be clear to the person skilled in the art that the permeability in a mineral oil deposit need not be homogeneous, but generally has a certain distribution, and the permeability figure stated for a mineral oil deposit is accordingly an average permeability.

For execution of the method, an aqueous formulation comprising, as well as water, at least the describe surfactant mixture of ionic surfactant (A) of the general formula (I) and the anionic surfactant (B) of the general formula (II) is used.

The formulation is made up in water comprising salts. It will be appreciated that these may be mixtures of different salts. For example, it is possible to use seawater to make up the aqueous formulation, or it is possible to use produced formation water, which is reused in this way. The injection water may alternatively be formation water from other nearby reservoirs or aquifers. In the case of offshore production platforms, the formulation is generally made up in seawater. In the case of onshore production platforms, the surfactant or polymer can advantageously first be dissolved in freshwater or low-salinity water, and the solution obtained can be diluted to the desired use concentration with formation water. The injection water may also be water originating from a desalination plant. Alternatively, starting from seawater, it would be possible, for example, to reduce the sulfate ion content such that modified seawater can be injected into a deposit rich in calcium ions without resultant precipitation.

In a preferred execution, the deposit water or the seawater is to include at least 100 ppm of divalent cations.

The salts may especially be alkali metal salts and alkaline earth metal salts. Examples of typical cations include Na⁺, K⁺, Mg²⁺ and/or Ca²⁺ and examples of typical anions include chloride, bromide, hydrogencarbonate, sulfate or borate.

In general, at least one or more than one alkali metal ions, especially at least Na⁺, is present. In addition, alkaline earth metal ions are also present, where the weight ratio of alkali metal ions/alkaline earth metal ions is generally a 2, preferably ≥3. Anions present are generally at least one or more than one halide ion, especially at least Cl⁻. In general, the amount of Cl⁻ is at least 50% by weight, preferably at least 80% by weight, based on the sum of all anions.

Additives can be used, for example, in order to prevent unwanted side effects, for example the unwanted precipitation of salts, or to stabilize the surfactant or polymer used. The polymer-containing formulations injected into the formation in the course of flooding flow only very gradually in the direction of the production well, meaning that they remain in the formation for a relatively long period under formation conditions. Degradation of the polymer results in a decrease in the viscosity. This has to be taken into account through the use of a higher amount of polymer, or it has to be accepted that the efficiency of the process will worsen. In any case, there is a deterioration in the economic viability of the process. A multitude of mechanisms can be responsible for the degradation of the polymer. By means of suitable additives, it is possible to prevent or at least delay the polymer degradation depending on the conditions.

In one embodiment of the invention, the aqueous formulation used comprises at least one oxygen scavenger. Oxygen scavengers react with oxygen that may be present in the aqueous formulation and hence prevent oxygen from being able to attack the polymer or polyether groups. Examples of oxygen scavengers include sulfites, for example Na₂SO₃, bisulfites, phosphites, hypophosphites or dithionites.

In a further embodiment of the invention, the aqueous formulation used comprises at least one free-radical scavenger. Free-radical scavengers can be used in order to counteract the degradation of the polymer or of the surfactant containing polyether groups by free radicals. Compounds of this kind (free-radical scavengers) can form stable compounds with free radicals. Free-radical scavengers are known in principle to those skilled in the art. For example, they may be stabilizers selected from the group of sulfur compounds, secondary amines, sterically hindered amines, N-oxides, nitroso compounds, aromatic hydroxyl compounds or ketones. Examples of sulfur compounds include thiourea, substituted thioureas such as N,N′-dimethylthiourea, N,N′-diethylthiourea, N,N′-diphenylthiourea, thiocyanates, for example ammonium thiocyanate or potassium thiocyanate, tetramethylthiuram disulfide, and mercaptans such as 2-mercaptobenzothiazole or 2-mercaptobenzimidazole or salts thereof, for example the sodium salts, sodium dimethyldithiocarbamate, 2,2′-dithiobis(benzothiazole), 4,4′-thiobis(6-t-butyl-m-cresol). Further examples include phenoxazine, salts of carboxylated phenoxazine, carboxylated phenoxazine, methylene blue, dicyandiamide, guanidine, cyanamide, paramethoxyphenol, sodium salt of paramethoxyphenol, 2-methylhydroquinone, salts of 2-methylhydroquinone, 2,6-di-t-butyl-4-methylphenol, butylhydroxyanisole, 8-hydroxyquinoline, 2,5-di(t-amyl)hydroquinone, 5-hydroxy-1,4-naphthoquinone, 2,5-di(t-amyl)hydroquinone, dimedone, propyl 3,4,5-trihydroxybenzoate, ammonium N-nitrosophenylhydroxylamine, 4-hydroxy-2,2,6,6-tetramethyloxypiperidine, N-(1,3-dimethylbutyl)-N′-phenyl-p-phenylenediamine and 1,2,2,6,6-pentamethyl-4-piperidinol. Preference is given to sterically hindered amines such as 1,2,2,6,6-pentamethyl-4-piperidinol and sulfur compounds, mercapto compounds, especially 2-mercaptobenzothiazole or 2-mercaptobenzimidazole or salts thereof, for example the sodium salts, and particular preference is given to 2-mercaptobenzothiazole or salts thereof.

In a further embodiment of the invention, the aqueous formulation used comprises at least one sacrificial reagent. Sacrificial reagents can react with free radicals and thus render them harmless. Examples include especially alcohols. Alcohols can be oxidized by free radicals, for example to ketones. Examples include monoalcohols and polyalcohols, for example 1-propanol, 2-propanol, propylene glycol, glycerol, butanediol or pentaerythritol.

In a further embodiment of the invention, the aqueous formulation used comprises at least one complexing agent. It is of course possible to use mixtures of various complexing agents. Complexing agents are generally anionic compounds which can complex especially divalent and higher-valency metal ions, for example Mg²⁺ or Ca²⁺. In this way, it is possible, for example, to prevent any unwanted precipitation. In addition, it is possible to prevent any polyvalent metal ions present from crosslinking the polymer by means of acidic groups present, especially COOH group. The complexing agents may especially be carboxylic acid or phosphonic acid derivatives. Examples of complexing agents include ethylenediaminetetra-acetic acid (EDTA), ethylenediaminedisuccinic acid (EDDS), diethylenetriaminepentamethylene-phosphonic acid (DTPMP), methylglycinediacetic acid (MGDA) and nitrilotriacetic acid (NTA). Of course, the corresponding salts of each may also be involved, for example the corresponding sodium salts. In a particularly preferred embodiment of the invention, MGDA is used as complexing agent.

As an alternative to or in addition to the abovementioned chelating agents, it is also possible to use polyacrylates.

In a further embodiment of the invention, the formulation comprises at least one organic cosolvent. These are preferably completely water-miscible solvents, but it is also possible to use solvents having only partial water miscibility. In general, the solubility should be at least 0.5 g/L, preferably at least 1 g/L. Examples include aliphatic C₄ to Ca alcohols, preferably C₄ to C₆ alcohols, which may be substituted by 1 to 5, preferably 1 to 3, ethyleneoxy units to achieve sufficient water solubility. Further examples include aliphatic diols having 2 to 8 carbon atoms, which may optionally also have further substitution. For example, the cosolvent may be at least one selected from the group of 2-butanol, 2 methyl-1-propanol, butylglycol, butyldiglycol and butyltriglycol.

The concentration of the polymer in the aqueous formulation is fixed such that the aqueous formulation has the desired viscosity or mobility control for the end use. The viscosity of the formulation should generally be at least 5 mPas (measured at 25° C. and a shear rate of 7 s⁻¹), preferably at least 10 mPas.

According to the invention, the concentration of the polymer in the formulation is 0.02% to 2% by weight, based on the sum total of all the components of the aqueous formulation. The amount is preferably 0.05% to 1% by weight, more preferably 0.1% to 0.8% by weight and, for example, 0.1% to 0.4% by weight.

The formulation comprising the possible aqueous polymer can be prepared by initially charging the water, sprinkling the polymer in as a powder and mixing it with the water. Apparatus for dissolving polymers and injecting the aqueous solutions into underground formations is known in principle to those skilled in the art.

The injecting of the aqueous formulation can be undertaken by means of customary apparatuses. The formulation can be injected into one or more injection wells by means of customary pumps. The injection wells are typically lined with steel tubes cemented in place, and the steel tubes are perforated at the desired point. The formulation enters the mineral oil formation from the injection well through the perforation. The pressure applied by means of the pumps, in a manner known in principle, is used to fix the flow rate of the formulation and hence also the shear stress with which the aqueous formulation enters the formation. The shear stress on entry into the formation can be calculated by the person skilled in the art in a manner known in principle on the basis of the Hagen-Poiseuille law, using the area through which the flow passes on entry into the formation, the mean pore radius and the volume flow rate. The average permeability of the formation can be found as described in a manner known in principle. Naturally, the greater the volume flow rate of aqueous polymer formulation injected into the formation, the greater the shear stress.

The rate of injection can be fixed by the person skilled in the art according to the conditions in the formation. Preferably, the shear rate on entry of the aqueous polymer formulation into the formation is at least 30 000 s⁻¹, preferably at least 60 000 s⁻¹ and more preferably at least 90 000 s⁻¹.

In one embodiment of the invention, the method of the invention is a flooding method in which a base and typically a complexing agent or a polyacrylate is used. This is typically the case when the proportion of polyvalent cations in the deposit water is low (100-400 ppm). An exception is sodium metaborate, which can be used as a base in the presence of significant amounts of polyvalent cations even without complexing agent.

The pH of the aqueous formulation is generally at least 8, preferably at least 9, especially 9 to 13, preferably 10 to 12 and, for example, 10.5 to 11.

In principle, it is possible to use any kind of base with which the desired pH can be attained, and the person skilled in the art will make a suitable selection. Examples of suitable bases include alkali metal hydroxides, for example NaOH or KOH, or alkali metal carbonates, for example Na₂CO₃. In addition, the bases may be basic salts, for example alkali metal salts of carboxylic acids, phosphoric acid, or especially complexing agents comprising acidic groups in the base form, such as EDTANa₄.

Mineral oil typically also comprises various carboxylic acids, for example naphthenic acids, which are converted to the corresponding salts by the basic formulation. The salts act as naturally occurring surfactants and thus support the process of oil removal.

With complexing agents, it is advantageously possible to prevent unwanted precipitation of sparingly soluble salts, especially Ca and Mg salts, when the alkaline aqueous formulation comes into contact with the corresponding metal ions and/or aqueous formulations comprising corresponding salts are used for the process. The amount of complexing agents is selected by the person skilled in the art. It may, for example, be 0.1% to 4% by weight, based on the sum total of all the components of the aqueous formulation.

In a particularly preferred embodiment of the invention, however, a method of mineral oil production is employed in which no base (e.g. alkali metal hydroxides or alkali metal carbonates) is used.

In a preferred execution of the invention, it is a characteristic feature of the method that the production of mineral oil from underground mineral oil deposits is a surfactant flooding method or a surfactant/polymer flooding method and not an alkali/surfactant/polymer flooding method and not a flooding method in which Na₂CO₃ is injected as well.

In a particularly preferred execution of the invention, it is a characteristic feature of the method that the production of mineral oil from underground mineral oil deposits is a Winsor type III microemulsion flooding method or a Winsor type III microemulsion/polymer flooding method and not an alkali/Winsor type III microemulsion/polymer flooding method and not a flooding method in which Na₂CO₃ is injected as well.

Preferably, the production of mineral oil from underground mineral oil deposits is effected by the method of the invention, i.e. by means of Winsor type III microemulsion flooding. In addition, the mineral oil deposit comprises carbonate rock. Illustrative compositions of carbonate rock can be found in example 5 on page 17 of WO 2015/173 339 A1. These compositions also form part of the subject matter of the present invention. The temperature of the deposit is preferably ≥90° C., more preferably ≥100° C., even more preferably ≥110° C. The stability of the formation water is preferably ≥50 000 ppm, more preferably ≥100 000 ppm TDS.

The salts in the deposit water may especially be alkali metal salts and alkaline earth metal salts. Examples of typical cations include Na⁺, K⁺, Mg²⁺ and/or Ca²⁺, and examples of typical anions include chloride, bromide, hydrogencarbonate, sulfate or borate. According to the invention, the deposit water should include at least 100 ppm of divalent cations. The amount of alkaline earth metal ions may preferably be 100 to 53 000 ppm, more preferably 120 ppm to 20 000 ppm and even more preferably 150 to 6000 ppm.

In general, at least one or more than one alkali metal ion is present, especially at least Na⁺. In addition, alkaline earth metal ions may also be present, in which case the weight ratio of alkali metal ions/alkaline earth metal ions is generally >2, preferably ≥3. Anions present are generally at least one or more than one halide ion(s), especially at least Cl⁻. In general, the amount of Cl⁻ is at least 50% by weight, preferably at least 80% by weight, based on the sum total of all the anions.

The pH of the formation water of the carbonate deposit is 3 to 10, preferably 5 to 9. The pH of the deposit is affected by factors including dissolved CO₂.

The concentration of all surfactants together is preferably 0.05% to 2% by weight, based on the total amount of the aqueous formulation injected. Preferably, the total surfactant concentration is 0.06% to 1% by weight, more preferably 0.08% to 0.5% by weight.

In a further preferred embodiment of the invention, at least one organic cosolvent can be added to the surfactant mixture of the invention. These are preferably completely water-miscible solvents, but it is also possible to use solvents having only partial water miscibility. In general, the solubility should be at least 1 g/L, preferably at least 5 g/L. Examples include aliphatic C3 to C8 alcohols, preferably C4 to C6 alcohols, further preferably C3 to C6 alcohols, which may be substituted by 1 to 5, preferably 1 to 3, ethyleneoxy units to achieve sufficient water solubility. Further examples include aliphatic diols having 2 to 8 carbon atoms, which may optionally also have further substitution. For example, the cosolvent may be at least one selected from the group of 2-butanol, 2-methyl-1-propanol, butyl ethylene glycol, butyl diethylene glycol or butyl triethylene glycol.

Within the context of the method of the invention for tertiary mineral oil production, the use of the surfactant mixture of the invention lowers the interfacial tension between oil and water to values of <0.1 mN/m, preferably to <0.05 mN/m, more preferably to <0.01 mN/m. Thus, the interfacial tension between oil and water is lowered to values in the range from 0.1 mN/m to 0.0001 mN/m, preferably to values in the range from 0.05 mN/m to 0.0001 mN/m, more preferably to values in the range from 0.01 mN/m to 0.0001 mN/m. The values reported are based on the prevailing deposit temperature.

It is possible for further surfactants (D) to be present in the aqueous saline surfactant formulation that are not identical to the surfactants (A) or (B) and
are from the group of the alkylbenzenesulfonates, alpha-olefinsulfonates, internal olefinsulfonates, paraffinsulfonates, where the surfactants have 14 to 28 carbon atoms; and/or
are selected from the group of the alkyl ethoxylates and alkyl polyglucosides, where the particular alkyl radical has 8 to 18 carbon atoms.

For the surfactants (D), particular preference is given to alkyl polyglucosides which have been formed from primary linear fatty alcohols having 8 to 14 carbon atoms and have a glucosidation level of 1 to 2, and alkyl ethoxylates which have been formed from primary alcohols having 10 to 18 carbon atoms and have an ethoxylation level of 5 to 50.

The present invention further provides a concentrate comprising a surfactant mixture as specified above, where the concentrate comprises 20% by weight to 90% by weight of the surfactant mixture, 5% by weight to 40% by weight of water and 5% by weight to 40% by weight of a cosolvent, based in each case on the total amount of the concentrate, where the concentrate of the surfactant mixture composed of ionic surfactant (A) of the general formula (I) and anionic surfactant (B) of the general formula (II) may be present in any desired molar ratio, but is preferably present in the ratio specified for the method of the invention.

Rather than a concentrate of the invention for the mixture, it is also possible to use a concentrate for the ionic surfactant (A) of the general formula (I) and/or a concentrate for the anionic surfactant (B) of the general formula (II), for example, in the method of the invention.

The present invention further provides a concentrate comprising

20% by weight to 80% by weight of at least one ionic surfactant (A) of the general formula (I) or of at least one anionic surfactant (B) of the general formula (II) or of a surfactant mixture of the invention, where the molar ratio of ionic surfactant (A) to anionic surfactant (B) may be as desired of ionic surfactant (A) to anionic surfactant (B) may be as desired;

70% by weight to 10% by weight of at least one anionic compound (C) of the general formula (III);

10% by weight to 70% by weight of water.

The water may be saline water, as observed in more detail above.

Accordingly, the aqueous saline surfactant formulation injected can be obtained in the method of the invention the surfactant mixture through admixing of a concentrate with surfactant mixture or through admixing of individual concentrates.

Accordingly, the administration of the surfactants composed ionic surfactant (A) of the general formula (I) and anionic surfactant (B) of the general formula (II) is possible, for example, in the form of concentrates. For example, the ionic surfactant (A) of the general formula (I) can be supplied as a concentrate, where the concentrate comprises 20% by weight to 90% by weight of surfactant (A), 5% by weight to 40% by weight of water and 5% by weight to 40% by weight of a cosolvent, based in each case on the total amount of the concentrate. The same applies to the anionic surfactant (B) of the general formula (II). It can be supplied as a concentrate where the concentrate comprises 20% by weight to 90% by weight of surfactant (B), 5% by weight to 40% by weight of water and 5% by weight to 40% by weight of a cosolvent, based in each case on the total amount of the concentrate. For the method of the invention, both concentrates can be introduced into and dissolved in the injection water in the desired ratio.

Therefore, the present invention further provides a concentrate comprising, based in each case on the total amount of the concentrate,

20% by weight to 90% by weight of at least one ionic surfactant (A) of the general formula (I) as specified above or at least one anionic surfactant (B) of the general formula (II) as specified above or a surfactant mixture as specified above, where the molar ratio of ionic surfactant (A) to anionic surfactant (B) may be as desired,

5% by weight to 40% by weight of water and

5% by weight to 40% by weight of a cosolvent.

In respect of the surfactant mixture, the ionic surfactant (A) and the anionic surfactant (B), the statements made above in the context of the method of the invention are still likewise applicable to the concentrate of the invention.

Preferably, the cosolvent is selected from the group of the aliphatic alcohols having 3 to 8 carbon atoms or from the group of the alkyl monoethylene glycols, the alkyl diethylene glycols or the alkyl triethylene glycols where the alkyl radical is an aliphatic hydrocarbyl radical having 3 to 6 carbon atoms. Further preferably, the concentrate of the invention is free-flowing or pumpable at 20° C. and has a viscosity 40° C. of <5000 mPas at 10 s⁻¹.

The concentrate may further comprise alkali metal chloride and diglycolic acid dialkali metal salt. It optionally also comprises chloroacetic acid alkali metal salt, glycolic acid alkali metal salt, water and/or a cosolvent. The cosolvent is, for example, butyl ethylene glycol, butyl diethylene glycol or butyl triethylene glycol.

The concentrate preferably comprises 0.5% to 15% by weight of a mixture comprising NaCl and diglycolic acid disodium salt, where NaCl is present in excess relative to diglycolic acid disodium salt.

Further preferably, the concentrate comprises butyl diethylene glycol as cosolvent.

The present invention further provides for the use of a surfactant mixture or of a concentrate of the invention for production of mineral oil from underground mineral oil deposits.

The present invention further provides for the use of a surfactant formulation as specified above for production of mineral oil from underground mineral oil deposits, especially under conditions as are described herein.

In respect of the surfactant mixture and also of the at least one hydrotrope (C), the statements made above in the context of the method of the invention are likewise applicable to the use of the invention.

Preferably, mineral oil is produced from underground mineral oil deposits by the method of the invention by means of Winsor type III microemulsion flooding. In addition, the mineral oil deposit comprises carbonate rock.

S. N. Ehrenberg and P. H. Nadeau compare sandstone deposits and carbonate deposits with regard to their porosity and deposit depth (AAPG Bulletin, V. 89, No. 4 (April 2005), pages 435-445). Carbonate deposits have a lower porosities on average than sandstone deposits.

Moreover, there may be ‘fractures’ with correspondingly high permeability, while there are simultaneously what are called matrix blocks with lower permeability. As a result, carbonate deposits can have regions having permeabilities of 1-100 mD (millidarcies) and/or regions having permeabilities of 10-100 mD and regions having permeabilities of >>100 mD. In addition, there are also deposits having a small number of fractures and relatively homogeneous matrix regions. For example, a carbonate deposit may have a porosity of 10%-40% (preferably 12%-35%) and permeabilities of 1-4000 mD (preferably 2-2000 mD, more preferably 5-500 mD).

Further descriptions of carbonate deposits can also be found in the two following publications:
Archie, Gustave Erdman. “Classification of carbonate reservoir rocks and petrophysical considerations.” Aapg Bulletin 36.2 (1952): 278-298.
Lucia, F. Jerry. Carbonate reservoir characterization: an integrated approach. Springer Science & Business Media, 2007.

The composition of carbonate rocks can vary. These also comprise, as well as calcite and/or dolomite, for example, ankerite, feldspar, quartz, clay minerals (e.g. kaolin, illite, smectite, chlorite), halites, iron oxides, pyrite, gypsum and/or epsomite. Preference is given to deposits having a high proportion of calcite (>90%, more preferably >95%) and a low quartz content (<5%, more preferably <2%) and a small proportion of clay minerals (<5%, more preferably <2%). Thus, a preferred deposit could include, for example, 98% calcite, 1% dolomite and 1% halite. Further illustrative compositions of carbonate rock can be found, for example, in table 2 of Colloids and Surfaces A: Physicochem. Eng. Aspects 450 (2014) 1-8 or in example 5 on page 17 of WO 2015/173 339 A1. The selection of surfactant mixtures as a function of rock compositions, temperature and salinity also forms part of the subject matter of the present invention. Preferably, the temperature of the deposit is ≥90° C., more preferably ≥100° C., even more preferably ≥110° C. The salinity of the formation water is preferably ≥50 000 ppm, more preferably ≥100 000 ppm and with further preference <210 000 ppm TDS.

More particularly, the use of the invention relates to a method according to the present invention, where the statements made above in respect of the method of the invention are correspondingly applicable to the use of the invention.

### EXPERIMENTAL EXAMPLES

Commercially Available Surfactants

Surfactants including the cationic surfactant cetyltrimethylammonium chloride (Dehyquart A-CA from BASF), the betaine surfactant C12C14-alkyl-dimethylbetaine (Dehyton AB 30 from BASF) and the cationic surfactant (2-hydroxyethyl)(2-hydroxyhexadecyl)dimethylammonium chloride (Dehyquart E-CA from BASF) were used.

### SYNTHESIS EXAMPLES

The examples which follow are intended to illustrate the invention and its advantages in detail:

Preparation of the Ionic Surfactants (A):

The following amines were used for the synthesis:

| Amine | Description |
|---|---|
| C₁₆N(CH₃)₂ | Commercially available tertiary N,N- |
| | dimethylalkylamine (C₁₆H₃₃—N(CH₃)₂ |
| | comprising a linear saturated C₁₆H₃₃ radical |
| | as alkyl radical: |
| | N,N-dimethylcetylamine |

1 a) C₁₆H₃₃—N⁺(CH₃)₂— CH₂CO₂

corresponding to ionic surfactant (A) of the general formula (I) (R¹)ₖ—N⁺(R²)₍₃₋ₖ₎R³(X⁻)ₗ with R¹═C₁₆H₃₃, R²═CH₃, k=1, R³═(CH₂CO₂)—, I=0.

In a 500 mL four-neck glass flask, 40.35 g (0.150 mol, 1.0 eq) of hexadecyldimethylamine, 24.7 g of butyl diethylene glycol and 82.8 g of water were mixed by stirring (400 revolutions per minute) at 20° C. The mixture was heated to 66° C., then 17.83 g (0.150 mol, 1.0 eq) of sodium chloride acetate were added in portions while stirring over the course of 90 minutes. During the first 30 minutes of the addition, the stirrer speed was increased from 400 to 600 revolutions per minute. After the addition had ended, the mixture was heated to 77° C. and stirred at this temperature for a further 10 hours. Analysis (¹H NMR in CDCl₃, ¹H NMR in MeOD, amine number, chloride content and mass spectrum) confirmed the desired composition C16H33-N(CH₃)₂— CH₂CO₂Na.

Preparation of the Anionic Surfactants (B):

### Abbreviations Used

EO ethyleneoxy
PO propyleneoxy

The following alcohols were used for the synthesis:

| Alcohol | Description |
|---|---|
| C₁₆C₁₈—OH | Commercially available tallow fatty alcohol mixture |
| | consisting of linear saturated primary C₁₆H₃₃—OH |
| | and C₁₈H₃₇—OH |
| C₂₄C₂₆C₂₈—OH | Guerbet alcohol mixture consisting of saturated |
| | primary alcohols having the branch in the 2 position: |
| | C₂₄H₄₉—OH, C₂₆H₅₃—OH and C₂₈H₅₇—OH; |
| | prepared by condensation reaction of linear C12C14 |
| | fatty alcohol, see also WO 2013-A 060 670 |

2 a) C16C18—7 PO—10 EO—CH₂CO₂Na

corresponding to anionic surfactant (B) of the general formula (II) R⁴—O—(CH₂C(R⁵)HO)ₘ—(CH₂C(CH₃)HO)ₙ—(CH₂CH₂O)ₒ—(CH₂)ₚ—Y⁻M⁺ with R⁴═C₁₆H₃₃/C₁₈H₃₇, m=0, n=7, o=10, p=1, Y═CO₂ and M=Na.

A 2 L pressure autoclave with anchor stirrer was initially charged with 304 g (1.19 mol) of C16C18 alcohol and the stirrer was switched on. Thereafter, 4.13 g of 50% aqueous KOH solution (0.037 mol KOH, 2.07 g KOH) were added, a vacuum of 25 mbar was applied, and the mixture was heated to 100° C. and kept there for 120 min in order to distill off the water. The mixture was purged three times with N₂. Thereafter, the vessel was checked for pressure-tightness, the pressure was adjusted to 1.0 bar gauge (2.0 bar absolute), the mixture was heated to 130° C. and then the pressure was adjusted to 2.0 bar absolute. At 150 revolutions per minute, 482 g (8.31 mol) of propylene oxide were metered in at 130° C. within 6 hours; pₘₐₓ was 6.0 bar absolute. The mixture was stirred at 130° C. for a further 2 h. 522 g (11.9 mol) of ethylene oxide were metered in at 130° C. within 10 h; pₘₐₓ was 5.0 bar absolute. The mixture was left to react for 1 h until the pressure was constant, cooled down to 100° C. and decompressed to 1.0 bar absolute. A vacuum of <10 mbar was applied and residual oxide was drawn off for 2 h. The vacuum was broken with N₂ and dispensing was effected at 80° C. under N₂. Analysis (mass spectrum, GPC, ¹H NMR in CDCl₃, ¹H NMR in MeOD) confirmed the mean composition C16C18—7 PO— 10 EO-H.

A 250 mL flange reactor with a three-level beam stirrer was charged with 165.3 g (0.150 mol, 1.0 eq) C16C18—7 PO—10 EO—H comprising 0.005 mol of C16C18—7 PO—10 EO—K and 24.1 g (0.203 mol, 1.35 eq) of chloroacetic acid sodium salt (98% purity) and stirred at 400 revolutions per minute under standard pressure at 45° C. for 15 min. Thereafter, the following procedure was conducted eight times: 1.02 g (0.0253 mol, 0.1688 eq) of NaOH microprills (diameter 0.5-1.5 mm) were introduced, a vacuum of 30 mbar was applied to remove the water of reaction, the mixture was stirred for 50 min, and then the vacuum was broken with N₂. A total of 8.1 g (0.203 mol, 1.35 eq) of NaOH microprills were added over a period of about 6.5 h. During the first hour of this period, the speed of rotation was increased to about 1000 revolutions per minute. Thereafter, the mixture was stirred at 45° C. and at 30 mbar for a further 3 h. The vacuum was broken with N₂ and the experiment was decanted out (yield >95%).

A white-yellowish viscous liquid was obtained at 20° C. The pH (5% in water) was 7.5. The water content was 1.5%. The molar proportion of chloroacetic acid sodium salt was about 2 mol %. The NaCl content is about 6.0% by weight. The OH number of the reaction mixture is 8.0 mg KOH/g. The molar proportion of glycolic acid sodium salt is about 3 mol %. In addition, a ¹H NMR spectrum (with and without trichloracetyl isocyanate shift reagent) was recorded. The carboxymethylation level is 85%. The desired structure was confirmed. 99 g of butyl diethylene glycol and 99 g of water were added. The surfactant content is 45 percent by weight.

2 b) C24C26C28—25 EO—CH₂CO₂Na

corresponding to anionic surfactant (B) of the general formula (II) R⁴—O—(CH₂C(R⁵)HO)ₘ—(CH₂C(CH₃)HO)ₙ—(CH₂CH₂O)ₒ—(CH₂)ₚ—Y⁻M⁺ with R⁴═C₂₄H₄₉/C₂₆H₅₃/C₂₈H₅₇, m=0, n=0, o=25, p=1, Y═CO₂ and M=Na.

A 2 L pressure autoclave with anchor stirrer was initially charged with 258 g (0.675 mol) of C24C26C28 alcohol and the stirrer was switched on. Thereafter, 4.0 g of 50% aqueous KOH solution (0.036 mol KOH, 2.0 g KOH) were added, a vacuum of 25 mbar was applied, and the mixture was heated to 100° C. and kept there for 120 min in order to distill off the water. The mixture was purged three times with N₂. Thereafter, the vessel was checked for pressure-tightness, the pressure was adjusted to 1.0 bar gauge (2.0 bar absolute), the mixture was heated to 140° C. and then the pressure was adjusted to 2.0 bar absolute. At 150 revolutions per minute, 742 g (16.86 mol) of ethylene oxide were metered in at 140° C. within 12 h. The mixture was left to react for 4 h until the pressure was constant, cooled down to 100° C. and decompressed to 1.0 bar absolute. A vacuum of <10 mbar was applied and residual oxide was drawn off for 2 h. The vacuum was broken with N₂ and dispensing was effected at 80° C. under N₂. Analysis (mass spectrum, GPC, ¹H NMR in CDCl₃, 1H NMR in MeOD) confirmed the mean composition C24C26C28—25 EO—H.

A 250 mL flange reactor with a three-level beam stirrer was charged with 152.4 g (0.103 mol, 1.0 eq) of C24C26C28—25 EO—H and 16.5 g (0.139 mol, 1.35 eq) of chloroacetic acid sodium salt (98% purity) and stirred at 400 revolutions per minute under standard pressure at 45° C. for 30 min. The mixture was heated to 50° C. Thereafter, the following procedure was conducted eight times: 0.695 g (0.0174 mol, 0.1688 eq) of NaOH microprills (diameter 0.5-1.5 mm) were introduced, a vacuum of 30 mbar was applied to remove the water of reaction, the mixture was stirred for 50 min, and then the vacuum was broken with N₂. A total of 5.55 g (0.139 mol, 1.35 eq) of NaOH microprills were added over a period of about 6.5 h. During the first hour of this period, the speed of rotation was increased to about 1000 revolutions per minute. Thereafter, the mixture was stirred at 50° C. and at 30 mbar for a further 16 h. The vacuum was broken with N₂ and the experiment was decanted out (yield >95%).

A white-yellowish viscous liquid was obtained at 20° C. The pH (5% in water) was 7.5. The water content was 1.5%. The molar proportion of chloroacetic acid sodium salt is about 7 mol %. The OH number of the reaction mixture is 8.9 mg KOH/g. The molar proportion of glycolic acid sodium salt is about 7.5 mol %. In addition, a ¹H NMR spectrum (with and without trichloroacetyl isocyanate shift reagent) was recorded. The desired structure was confirmed. The carboxymethylation level is 85%. 37.5 g of butyl diethylene glycol and 37.5 g of water were added to 75 g of the above crude carboxylate. The surfactant content is 45 percent by weight.

2 c) C16C18—7 PO—15 EO—CH₂CO₂Na

corresponding to anionic surfactant (B) of the general formula (II) R⁴—O—(CH₂C(R⁵)HO)ₘ—(CH₂C(CH₃)HO)—(CH₂CH₂O)ₒ—(CH₂)ₚ—Y⁻M⁺ with R⁴═C₁₆H₃₃/C₁₈H₃₇, m=0, n=7, o=15, p=1, Y═CO₂ and M=Na.

A 2 L pressure autoclave with anchor stirrer was initially charged with 261.6 g (1.0 mol) of C16C18 alcohol and the stirrer was switched on. Thereafter, 4.5 g of 50% aqueous KOH solution (0.04 mol KOH, 2.25 g KOH) were added, a vacuum of 25 mbar was applied, and the mixture was heated to 100° C. and kept there for 120 min in order to distill off the water. The mixture was purged three times with N₂. Thereafter, the vessel was checked for pressure-tightness, the pressure was adjusted to 1.0 bar gauge (2.0 bar absolute), the mixture was heated to 135° C. and then the pressure was adjusted to 2.2 bar absolute. At 125 revolutions per minute, 412.4 g (7.1 mol) of propylene oxide were metered in at 135° C. within 6 h; pₘₐₓ was 6.0 bar absolute. Stirring was continued at 135° C. for 4 h. 674 g (15.3 mol) of ethylene oxide were metered in at 135° C. within 8 h; pₘₐₓ was 5.0 bar absolute. The mixture was left to react for 6 h until the pressure was constant, cooled down to 100° C. and decompressed to 1.0 bar absolute. A vacuum of <10 mbar was applied and residual oxide was drawn off for 2 h. The vacuum was broken with N₂ and dispensing was effected at 80° C. under N₂. Analysis (mass spectrum, GPC, ¹H-NMR in CDCl₃, ¹H-NMR in MeOD) confirmed the mean composition C16C18—7 PO—15 EO—H.

A 750 mL flange reactor with a three-level beam stirrer was charged with 400 g (0.30 mol, 1.0 eq) of C16C18—7 PO—15 EO—H, containing 0.012 mol of C16C18—7 PO—15 EO—K, and stirred at 70° C. (750 revolutions per minute). Thereafter, the following procedure was conducted 12 times: 5.34 g of 50% aqueous sodium hydroxide solution were metered in at 70° C. and a reduced pressure of 12 mbar absolute was applied for 15 minutes at 70° C. to remove the water, then the pressure was broken by addition of nitrogen, and subsequently 3.94 g of 80% chloroacetic acid in water were metered in at 70° C. and a reduced pressure of 12 mbar absolute was applied at 70° C. for 15 minutes for removal of water, and was broken again by addition of nitrogen. In this way a total of 64.10 g (0.80 mol, 32.05 g NaOH, 2.67 eq) of 50% aqueous sodium hydroxide solution and 47.32 g (0.40 mol, 1.33 eq) of 80% chloroacetic acid in water were metered in at 70° C. within 7 h. The mixture was subsequently stirred for 20 minutes more. The experiment was decanted out (yield >95%).

A white-yellowish viscous liquid was obtained at 20° C. The pH (5% in water) was 12. The water content was 0.45%. The molar proportion of chloroacetic acid sodium salt is about 2 mol %. The NaCl content is about 5.1% by weight. The OH number of the reaction mixture is 8.3 mg KOH/g. The molar proportion of glycolic acid sodium salt is about 3.5 mol %. In addition, a ¹H NMR spectrum (with and without trichloroacetyl isocyanate shift reagent) was recorded. The carboxymethylation level is 83%. The desired structure was confirmed.

365 g of the above crude carboxylate were stirred at 25° C. The pH was adjusted to 7.6 by addition of acetic acid. 182.5 g of butyl diethylene glycol and 182.5 g of water were added. The surfactant content of the concentrate is about 45 percent by weight.

2 d) C16C18—10 EO—CH₂CO₂Na

corresponding to anionic surfactant (B) of the general formula (II) R⁴—O—(CH₂C(R⁵)HO)ₘ—(CH₂C(CH₃)HO)ₙ—(CH₂CH₂O)ₒ—(CH₂)ₚ—Y⁻M⁺ with R⁴═C₁₆H₃₃/C₁₈H₃₇, m=0, n=0, o=10, p=1, Y═CO₂ and M=Na.

A 2 L pressure autoclave with anchor stirrer was initially charged with 392.4 g (1.5 mol) of C16C18 alcohol and the stirrer was switched on. Thereafter, 4.2 g of 50% aqueous KOH solution (0.038 mol KOH, 2.1 g KOH) were added, a vacuum of 25 mbar was applied, and the mixture was heated to 120° C. and kept there for 120 min in order to distill off the water. The mixture was purged three times with N₂. Thereafter, the vessel was checked for pressure-tightness, the pressure was adjusted to 1.0 bar gauge (2.0 bar absolute), the mixture was heated to 130° C. and then the pressure was adjusted to 2.3 bar absolute. 660.8 g (15 mol) of ethylene oxide were metered in at 130° C. within 7 h; pₘₐₓ was 6.0 bar absolute. The mixture was left to react for 6 h until the pressure was constant, cooled down to 100° C. and decompressed to 1.0 bar absolute. A vacuum of <10 mbar was applied and residual oxide was drawn off for 2 h. The vacuum was broken with N₂ and dispensing was effected at 80° C. under N₂. Analysis (mass spectrum, GPC, 1H NMR in CDCl₃, 1 H NMR in MeOD) confirmed the mean composition C16C18—10 EO—H.

A 250 mL flange reactor with a three-level beam stirrer was charged with 160 g (0.228 mol, 1.0 eq) of C16C18—10 EO—H containing 0.006 mol of C16C18—10 EO—K and 36.6 g (0.308 mol, 1.35 eq) of chloroacetic acid sodium salt (98% purity) and the mixture was stirred under atmospheric pressure at 400 revolutions per minute and at 45° C. for 15 min. Thereafter, the following procedure was conducted eight times: 1.54 g (0.0384 mol, 0.1686 eq) of NaOH microprills (diameter 0.5-1.5 mm) was introduced, a vacuum of 30 mbar absolute was applied to remove the water of reaction, the mixture was stirred for 50 min, and then the vacuum was broken with N₂. A total of 12.3 g (0.308 mol, 1.35 eq) of NaOH microprills was added over a period of about 7 h. During the first hour of this period, the speed of rotation was increased to about 1000 revolutions per minute. Thereafter, the mixture was stirred at 45° C. and at 45 mbar absolute for a further 45 min, and at 45° C. and 60 mbar absolute for a further 15 h. The vacuum was broken with N₂ and the experiment was decanted out (yield >95%).

A liquid that was white-yellowish and viscous at 20° C. was obtained. The pH (5% in water) was 8.9. The water content was 1.5%. The molar proportion of chloroacetic acid sodium salt is about 2 mol %. The NaCl content is about 8.7% by weight. The OH number of the reaction mixture is 5.8 mg KOH/g. The molar proportion of glycolic acid sodium salt is about 2 mol %. In addition, a ¹H NMR spectrum (with and without trichloroacetyl isocyanate shift reagent) was recorded. The carboxymethylation level is 93%. The desired structure was confirmed. 106.9 g of the above crude carboxylate were stirred at 25° C. 52.7 g of butyl diethylene glycol and 51.1 g of water were added. The surfactant content is 42 percent by weight.

Preparation of the Anionic Hydrotrope (C):

### Abbreviations Used

EO ethyleneoxy

The following alcohol ethoxylates were used for the synthesis:

| Alcohol | |
|---|---|
| ethoxylate | Description |
| C₄—2EO—H | Commercially available butyl diethylene glycol. The |
| | butyl radical is linear and saturated. (Monodisperse) |
| | butyl diethylene glycol content >98%. |
| C₄—3EO—H | Commercially available mixture of butyl triethylene |
| | glycol and butyl tetraethylene glycol in an approximate |
| | ratio of 75:25 (based on weight). The butyl radical is |
| | linear and saturated. |
| C₆—2EO—H | Commercially available phenyl diethylene glycol. |

3 a) C4—2 EO—CH₂CO₂Na

corresponding to anionic hydrotrope (C) of the general formula (III) R⁶—O—(CH₂CH₂O)_{q}—CH₂CO₂-M⁺ with R⁶=n-C₄Hg, q=2, and M=Na.

A 250 mL flange reactor with three-level beam stirrer was charged with 76.25 g (0.47 mol, 1.0 eq) of butyl diethylene glycol and this initial charge was stirred at 55° C. and 400 revolutions per minute. Then 75.41 g (0.6345 mol, 1.35 eq) of chloroacetic acid sodium salt (98% purity) were added and the mixture was stirred under atmospheric pressure at 55° C. for 30 min at 600 revolutions per minute. Thereafter, the following procedure was conducted eight times: 3.17 g (0.079 mol, 0.1688 eq) of NaOH microprills (diameter 0.5-1.5 mm) were introduced, a vacuum of 120 mbar was applied to remove the water of reaction, the mixture was stirred for about 60 min, and then the vacuum was broken with N₂. In total, 25.38 g (0.6345 mol, 1.35 eq) of NaOH microprills were added over a period of about 8 h. During the first hour of this period, the speed of rotation was increased to about 1000 revolutions per minute. Thereafter, the vacuum was broken with N₂ and the experiment was stirred further under atmospheric pressure at 55° C. for 16 h. Subsequently the experiment was decanted out to give 159 g (yield 95%). A ¹H NMR spectrum was recorded in CDCl₃ (with and without trichloroacetyl isocyanate shift reagent) and also in MeOD. The desired structure was confirmed by ¹H NMR. A small sample was then brought to a pH of 2 in MeOD by addition of acid and was analyzed by ¹H NMR spectroscopy. The carboxymethylation level is 92%. 159 g of water were added to the crude mixture. The C₄-2EO-CH₂CO₂Na hydrotrope content is 33 percent by weight.

Application Tests:

Preparation of the Aqueous Salt Solutions

Three different aqueous salt solutions were prepared. For this purpose, salts were weighed into distilled water and dissolved by stirring at 20° C. Finally, the pH was adjusted, the solution was stored under seal and the salt solution was checked for clarity for several days:
synthetic seawater with TDS 43 910 ppm comprising 30.53 g/L NaCl, 2.11 g/L CaCl₂×2 H₂O, 13.97 g/L MgCl₂×6 H₂O, 5.03 g of Na₂SO₄, 0.21 g of NaHCO₃—pH adjusted to 8.0
illustrative synthetic deposit water I with TDS 138 656 ppm comprising 103.50 g/L NaCl, 35.59 g/L CaCl₂×2 H₂O, 17.14 g/L MgCl₂×6 H₂O, 0.25 g of NaHCO₃—pH adjusted to 7.0
illustrative synthetic deposit water II with TDS 234 370 ppm comprising 171.99 g/L NaCl, 69.06 g/L CaCl₂×2 H₂O, 20.33 g/L MgCl₂×6 H₂O, 0.41 g of Na₂SO₄, 0.29 g of NaHCO₃-pH adjusted to 6.0

Determination of Solubility

The surfactants were dissolved in saline water in the concentration to be examined in each case. In order to avoid degradation of the surfactants by oxygen at high temperatures, NaMBT and Na₂SO₃ were used as free-radical scavenger and as oxygen scavenger. In addition, an argon atmosphere was employed and aqueous surfactant solutions were freed of oxygen by introducing argon for 30 minutes. A screwtop glass vessel was used, which was rated for pressures up to 5 bar absolute.

The surfactants were stirred with the respective salt composition in the concentration to be examined in each case in saline water at 20-30° C. for 30 min. For surfactant mixtures, for example, the anionic surfactant (A) of the general formula (I) (optionally in the form of a concentrate) was dissolved in the desired saltwater (which comprised free-radical scavenger and oxygen scavenger) in a first vessel. In a second vessel, the anionic surfactant (B) of the general formula (II) (optionally in the form of a concentrate) was dissolved in the desired saltwater (which comprised free-radical scavenger and oxygen scavenger). Subsequently, the two solutions were combined at 20-30° C. and then heated to the target temperature. Alternatively, the anionic surfactant (A) of the general formula (I) and the anionic surfactant (B) of the general formula (II) were predissolved in demineralized water or water of low salinity (<10 000 ppm) (addition in the form of the concentrated single surfactants or as a concentrated mixture) and then mixed with a salt water solution (which comprised free-radical scavenger and oxygen scavenger) (only in exceptional cases was the surfactant dissolved in water; if required, the pH was adjusted to a range from 6 to 8 by addition of aqueous hydrochloric acid and appropriate amounts of the particular salt were dissolved at 20° C.). This was followed by heating. Thereafter, there was stepwise heating until turbidity or a phase separation set in. Thereafter, the mixture was cooled cautiously and the point at which the solution clarified again or became slightly scattering was noted. This was recorded as the cloud point.

At particular fixed temperatures, the appearance of the surfactant solution in saline water was noted. Clear solutions or solutions that are slightly scattering and become somewhat lighter in color through gentle shear (but do not foam up with time) are regarded as acceptable. Said slightly scattering surfactant solutions are filtered through a filter having pore size of 2 mm. No separation at all was observed.

The figures for the amounts of surfactant were reported as grams of active substance (calc. surfactant content 100%) per liter of saltwater.

Determination of Thermal Stability

The surfactants were dissolved in saline water in the concentration to be examined in each case. In order to prevent degradation of the surfactants by oxygen at high temperatures, NaMBT and Na₂SO₃ were used as free-radical scavenger and as oxygen scavenger (for example 1 percent by weight of surfactant based on active content in the aqueous salt solution comprising 50 ppm Na₂SO₃ and 20 ppm NaMBT). In addition, an argon atmosphere was employed and the aqueous surfactant solutions were freed of oxygen by introducing argon for 30 minutes. A screwtop glass vessel which was rated for pressures up to 5 bar absolute was used.

The surfactants were stirred with the respective salt composition in the concentration to be examined in each case in saline water at 20-30° C. for 30 min (alternatively, the surfactant was dissolved in water; if required, the pH was adjusted to a range from 6 to 8 by addition of aqueous hydrochloric acid and appropriate amounts of the particular salt were dissolved at 20° C.). Thereafter, the mixture was heated to 125° C. For each mixture, several tubes containing said solution were made up and all were stored at 125° C. After 0, 2, 4, 8 and 12 weeks, one tube of solution in each case was cooled down to 20° C. and freshly opened. Subsequently, by HPLC chromatography (column: 125*3 mm LiChrospher RP8 M+N, gradient mode with solvent A [1900 mL of water+100 mL of 0.1M ammonium acetate] and solvent B [methanol/acetonitrile 8/2 V/V], light scattering detector), the surfactant solution that had been stored at temperature was examined and the percentage amount of starting surfactant that was intact was determined. Measurement accuracy was +−2 to +−4%. Opened tubes of solution were not stored further in order to rule out contamination with oxygen as a distorting value.

Determination of Phase Behavior

The surfactant solutions (10 g of surfactant based on active content in 1 liter of the aqueous salt solution comprising 50 ppm Na₂SO₃ and 20 ppm NaMBT), which have been prepared for the above determinations of solubility, were admixed with a particular amount of oil (water/oil ratio of 4:1 or 1:1 based on volume) and stored under an argon atmosphere in a sealable graduated vessel at 125° C. for seven or 14 days. During this time, the vessels were turned upside down and upright again once per day. It was noted with reference to the graduation whether emulsions or microemulsions had formed. In the case of mobile middle phases (Winsor type III microemulsion), the SP* or SP_{O} was determined (see paragraph below).

Determination of Interfacial Tension

The interfacial tension between water and oil was determined in a known manner by the measurement of the solubilization parameter SP*. The determination of the interfacial tension via the determination of the solubilization parameter SP* is an accepted method in the technical field for approximate determination of interfacial tension. The solubilization parameter SP* indicates how many mL of oil is dissolved in a microemulsion (Winsor type III) per mL of surfactant used. The interfacial tension a (IFT) can be calculated from this via the approximation formula IFT≈0.3/[(SP*)²] if the same volumes of water and oil are used (C. Huh, J. Coll. Interf. Sc., Vol. 71, No. 2 (1979)).

If different volumes of water and oil were used, the solubilization parameter SP_{O} was determined. This indicates how much oil was microemulsified in the middle phase (Winsor type III microemulsion) per amount of surfactant used. Using the above equation, it is analogously possible to estimate the interfacial tension. For unbalanced Winsor type III microemulsions, it is possible to work out SP* via the formula 2/[SP*]=1/[SP_{O}]+1/[SP_{W}] (S. Gosh, R. T. Johns, Langmuir 2016, 32, 8969-8979). The interfacial tension can again be calculated via the above approximation formula IFT=0.3/[(Sp*)²].

Alternatively, interfacial tensions of crude oil with respect to saline water in the presence of the surfactant solution at temperature were determined by the spinning drop method using an SVT20 from DataPhysics. For this purpose, an oil droplet was injected into a capillary filled with saline surfactant solution at temperature and the expansion of the droplet at around 4500 revolutions per minute was observed and the evolution of the interfacial tension with time was noted. The interfacial tension IFT (or s 11) is calculated here—as described by Hans-Dieter Dirfler in “Grenzflachen and kolloid-disperse Systeme” [Interfaces and Colloidally Dispersed Systems] Springer Verlag Berlin Heidelberg 2002—by the following formula from the cylinder diameter d_{z}, the speed w, and the density differential

(d₁−d₂):s_{∥}=0.25·d_{z}³·w2·(d₁−d₂).

The amounts of surfactant were reported as grams of the active substance (calculated for 100% surfactant content) per liter of saltwater.

Specification of API Gravity

API gravity (American Petroleum Institute gravity) is a conventional density unit for crude oils which is in common use in the USA. It is used globally for characterization and as a quality yardstick for crude oil. The API gravity is calculated from the relative density prel of the crude oil at 60° F. (15.56° C.) based on water by

API gravity=(141.5/pᵣₑₗ)−131.5.

The test results for solubility and for interfacial tension after 0.75 to 7.5 h are shown in table 1.

TABLE 1
Solubilities in salt water and interfacial tension with surfactant mixture of ionic surfactant (A) of the general
formula (I) and anionic surfactant (B) of the general formula (II) on crude oil with API gravity 35

| | | | | | | Surfactant |
|---|---|---|---|---|---|---|
| | | | | | | solubility |
| | Surfactant formulation | | | SP* or | | in salt |
| Exam- | with 10 g/L active | Salt | Water/oil | SPo at | IFT at | solution at |
| ple | substance in salt solution | solution | ratio | 125° C. | 125° C. | 125° C. |
| 1 | 61 mol % | Salt content | 1:1 | 6.25 | 0.0077 | clearly |
| | C16N(CH₃)₃Cl^{a} to | 138656 ppm | | | mN/m | soluble |
| | 39 mol % | (deposit | | | | |
| | C16C18—7PO—10EO—CH₂CO₂Na^{d} | water I) | | | | |
| 2 | 61 mol % | Salt content | 4:1 | 8 | 0.0047 | clearly |
| | C16N(CH₃)₃Cl^{a} to | 138656 ppm | | | mN/m | soluble |
| | 39 mol % | (deposit | | | | |
| | C16C18—7PO—10EO—CH₂CO₂Na^{d} | water I) | | | | |
| C3 | 100 mol % | Salt content | 4:1 | no Winsor | >0.1 | clearly |
| | C16N(CH₃)₃Cl^{a} | 138656 ppm | | type III | mN/m | soluble |
| | | (deposit | | micro- | | |
| | | water I) | | emulsion | | |
| C4 | 100 mol % | Salt content | 100:0 | — | — | insoluble |
| | C16C18—7PO—10EO—CH₂CO₂Na^{d} | 138656 ppm | | | | |
| | | (deposit | | | | |
| | | water I) | | | | |
| 5 | 64 mol % | Salt content | 4:1 | 7 | 0.0061 | clearly |
| | C12C14N(CH₃)₂CH₂CO₂^{c} | 138656 ppm | | | mN/m | soluble |
| | to 36 mol % | (deposit | | | | |
| | C16C18—7PO—10EO—CH₂CO₂Na^{d} | water I) | | | | |
| C6 | 100 mol % | Salt content | 4:1 | no Winsor | >0.1 | clearly |
| | C12C14N(CH₃)₂CH₂CO₂^{c} | 138656 ppm | | type III | mN/m | soluble |
| | | (deposit | | micro- | | |
| | | water I) | | emulsion | | |
| 7 | 67 mol % | Salt content | 1:1 | 7 | 0.0061 | clearly |
| | C16N(CH₃)₂CH₂CO₂^{b} | 138656 ppm | | | mN/m | soluble |
| | to 33 mol % | (deposit | | | | |
| | C24C26C28—25EO—CH₂CO₂Na^{e} | water I) | | | | |
| 8 | 67 mol % | Salt content | 4:1 | 5 | 0.012 | clearly |
| | C16N(CH₃)₂CH₂CO₂^{b} | 138656 ppm | | | mN/m | soluble |
| | to 33 mol % | (deposit | | | | |
| | C24C26C28—25EO—CH₂CO₂Na^{e} | water I) | | | | |
| C9 | 100 mol % | Salt content | 4:1 | no Winsor | >0.1 | clearly |
| | C16N(CH₃)₂CH₂CO₂^{b} | 138656 ppm | | type III | mN/m | soluble |
| | | (deposit | | micro- | | |
| | | water I) | | emulsion | | |
| C10 | 100 mol % | Salt content | 100:0 | — | — | insoluble |
| | C24C26C28—25EO—CH₂CO₂Na^{e} | 138656 ppm | | | | |
| | | (deposit | | | | |
| | | water I) | | | | |

^{a}from Dehyquart A-CA [corresponding to ionic surfactant (A) of the general formula (I) with R¹ = nC₁₆H₃₃, k = 1, R² = CH₃, R³ = CH₃, X = Cl and I = 1]
^{b}from ex. 1a) [corresponding to ionic surfactant (A) of the general formula (I) with R¹ = nC₁₆H₃₃, k = 1, R² = CH₃, R³ = (CH₂CO₂)⁻ and I = 0]
^{c}from Dehyton AB 30 [corresponding to ionic surfactant (A) of the general formula (I) with R¹ = nC₁₂H₂₅/C₁₄H₂₉, k = 1, R² = CH₃, R³ = (CH₂CO₂)⁻ and I = 0]
^{d}from ex. 2a) [corresponding to anionic surfactant (B) of the general formula (II) with R⁴ = nC₁₆H₃₃/C₁₈H₃₇, m = 0, n = 7, o = 10, p = 1, Y = CH₂CO₂ and M = Na]
^{e}from ex. 2b) [corresponding to ionic surfactant (B) of the general formula (II) with R⁴ = C₂₄H₄₉/C₂₆H₅₃/C₂₈H₅₇, m = 0, n = 0, o = 25, p = 1, Y = CH₂CO₂ and M = Na]

As can be seen in examples 1, 2, 5, 7 and 8 of table 1, the claimed surfactant mixtures, under difficult field conditions (125° C., salt content 138656 ppm, polyvalent cations), afford Winsor type III microemulsions with very low to ultralow interfacial tensions of 0.012 mN/m to 0.0047 mN/m.

This is also the case for different water/oil ratios and shows the robustness of the system. The use of the individual surfactants in comparative examples C3, C4, C6, C9 and C10 indicates that Winsor type III microemulsions are not formed or that they are insoluble under the conditions.

TABLE 2
Storage stability of the ionic surfactant (A) of the general formula (I) and of
the anionic surfactant (B) of the general formula (II) in saltwater at 125° C.

| | | | Intact | Intact | Intact | Intact |
|---|---|---|---|---|---|---|
| | | | surfactant | surfactant | surfactant | surfactant |
| | | | after 2 | after 4 | after 8 | after 12 |
| Exam- | Surfactant with 5 g/L active | Salt | weeks at | weeks at | weeks at | weeks at |
| ple | substance in solution | solution | 125° C. | 125° C. | 125° C. | 125° C. |
| 1 | C16C18—7PO—10EO—CH₂CO₂Na^{d} | 10000 ppm | 100% | 100% | 100% | 100% |
| | | NaCl (pH 8) | | | | |
| C2 | (2- | Synthetic | 92% | 88% | 82% | 75% |
| | Hydroxyethyl)-2- | seawater | | | | |
| | hydroxyhexa- | with TDS | | | | |
| | decyl)dimethyl- | 43910 ppm | | | | |
| | ammonium | (pH 8) | | | | |
| | chloride^{f} | | | | | |
| 3 | C16N(CH₃)₃Cl^{a} | Synthetic | 98% | 94% | 92% | 90% |
| | | seawater | | | | |
| | | with TDS | | | | |
| | | 43910 ppm | | | | |
| | | (pH 8) | | | | |
| 4 | C12C14N(CH₃)₂CH₂CO₂^{c} | Deposit | 100% | 98% | 93% | 90% |
| | | water II | | | | |
| | | with TDS | | | | |
| | | 234370 ppm | | | | |
| | | (pH 6) | | | | |

^{a}from Dehyquart A-CA [corresponding to ionic surfactant (A) of the general formula (I) with R¹ = nC₁₆H₃₃, k = 1, R² = CH₃, R³ = CH₃, X = Cl and I = 1]
^{c}from Dehyton AB 30 [corresponding to ionic surfactant (A) of the general formula (I) with R¹ = nC₁₂H₂₅/C₁₄H₂₉, k = 1, R² = CH₃, R³ = (CH₂CO₂)⁻ and I = 0]
^{d}from ex. 2a) [corresponding to anionic surfactant (B) of the general formula (II) with R⁴ = nC₁₆H₃₃/C₁₈H₃₇, m = 0, n = 7, o = 10, p = 1, Y = CH₂CO₂ and M = Na]
^{f}from Dehyquart E-CA [(2-hydroxyethyl)(2-hydroxyhexadecyl)dimethylammonium chloride]

As can be seen in example 1 of table 2, with exclusion of oxygen, the anionic surfactant (B) of the general formula (II) is stable at 125° C. for 12 weeks (the table does not show further tests that showed that the surfactant from example 1 remains completely stable even for 12 weeks at 150° C.). Because of the surfactant solubility at 125° C., in this example, the test was conducted in 1% sodium chloride solution. The noninventive cationic surfactant in comparative example C₂ in table 2, by contrast, shows significant degradation. After 12 weeks at 125° C., only 75% of the starting amount is intact. This is not very surprising since cationic surfactants can be subject to Hofmann elimination which can especially occur at high temperatures. In Hofmann elimination, quaternary ammonium compounds having hydrogen atoms in the β position are degraded to tertiary amines. Very much more surprising, by contrast, is the finding from examples 3 and 4. The inventive cationic or betaine surfactants (A) of the general formula (I) are much more stable at 125° C. Thus, after 12 weeks at 125° C., 90% of the starting amount of intact surfactant is still present.

In order to demonstrate the broad applicability of the formulations claimed, further studies were conducted.

TABLE 3
Interfacial tension with surfactant mixture of ionic surfactant (A) of the general formula (I) and anionic
surfactant (B) of the general formula (II) in different crude oils with different API gravities

| | Surfactant formulation | | | | | |
|---|---|---|---|---|---|---|
| Exam- | with 10 g/L active | Salt | Water/oil | SP* at | IFT at | API of the |
| ple | substance in salt solution | solution | ratio | 125° C. | 125° C. | crude oil |
| 1 | 61 mol % C16N(CH₃)₃Cl^{a} | Salt content | 4:1 | 8 | 0.0047 | 35 |
| | to 39 mol % | 138656 ppm | | | mN/m | |
| | C16C18—7PO—10EO—CH₂CO₂Na^{d} | (deposit | | | | |
| | | water I) | | | | |
| 2 | 61 mol % C16N(CH₃)₃Cl^{a} | Salt content | 4:1 | 7 | 0.0061 | 34 |
| | to 39 mol % | 138656 ppm | | | mN/m | |
| | C16C18—7PO—10EO—CH₂CO₂Na^{d} | (deposit | | | | |
| | | water I) | | | | |
| 3 | 61 mol % C16N(CH₃)₃Cl^{a} | Salt content | 4:1 | 8 | 0.0047 | 36 |
| | to 39 mol % | 138656 ppm | | | mN/m | |
| | C16C18—7PO—10EO—CH₂CO₂Na^{d} | (deposit | | | | |
| | | water I) | | | | |

^{a}from Dehyquart A-CA [corresponding to ionic surfactant (A) of the general formula (I) with R¹ = nC₁₆H₃₃, k = 1, R² = CH₃, R³ = CH₃, X = Cl and I = 1]
^{d}from ex. 2a) [corresponding to anionic surfactant (B) of the general formula (II) with R⁴ = nC₁₆H₃₃/C₁₈H₃₇, m = 0, n = 7, o = 10, p = 1, Y = CH₂CO₂ and M = Na]

As can be seen in examples 1, 2 and 3 from table 3, one of the surfactant mixtures claimed, under difficult field conditions (125° C., salt content 138656 ppm, polyvalent cations), affords Winsor type III microemulsions with very low to ultralow interfacial tensions of 0.0047 mN/mn to 0.0061 mN/m. This is also the case for different crude oils with different API gravity and shows the robustness of the system.

TABLE 4
Solubilities in salt water of different salinity and interfacial tension with
surfactant mixture of ionic surfactant (A) of the general formula (I) and anionic
surfactant (B) of the general formula (II) in crude oil with API gravity 35

| | | | | | | Surfactant |
|---|---|---|---|---|---|---|
| | | | | | | solubility |
| | Surfactant formulation | | | SP* (or | | in salt |
| Exam- | with 10 g/L active | Salt | Water/oil | SPo) at | IFT at | solution at |
| ple | substance in salt solution | solution | ratio | 125° C. | 125° C. | 125° C. |
| 1 | 64 mol % | Salt content | 4:1 | 7 | 0.0061 | clearly |
| | C12C14N(CH₃)₂CH₂CO₂^{c} | 138656 ppm | | | mN/m | soluble |
| | to 36 mol % | (deposit | | | | |
| | C16C18—7PO—10EO—CH₂CO₂Na^{d} | water I) | | | | |
| 2 | 69 mol % | Salt content | 4:1 | 6.3 | 0.0076 | clearly |
| | C12C14N(CH₃)₂CH₂CO₂^{c} | 200000 ppm | | | mN/m | soluble |
| | to 31 mol % | (deposit | | | | |
| | C16C18—7PO—10EO—CH₂CO₂Na^{d} | water II | | | | |
| | | diluted with | | | | |
| | | demineralized | | | | |
| | | water) | | | | |
| 3 | 69 mol % | Salt content | 4:1 | 5.8 | 0.0089 | clearly |
| | C12C14N(CH₃)₂CH₂CO₂^{c} | 210000 ppm | | | mN/m | soluble |
| | to 31 mol % | (deposit | | | | |
| | C16C18—7PO—10EO—CH₂CO₂Na^{d} | water II | | | | |
| | | diluted with | | | | |
| | | demineralized | | | | |
| | | water) | | | | |

^{c}from Dehyton AB 30 [corresponding to ionic surfactant (A) of the general formula (I) with R¹ = nC₁₂H₂₅/C₁₄H₂₉, k = 1, R² = CH₃, R³ = (CH₂CO₂)⁻ and I = 0]
^{d}from ex. 2a) [corresponding to anionic surfactant (B) of the general formula (II) with R⁴ = nC₁₆H₃₃/C₁₈H₃₇, m = 0, n = 7, o = 10, p = 1, Y = CH₂CO₂ and M = Na]

As can be seen in examples 1, 2 and 3 in table 4, claimed surfactant mixtures, under difficult field conditions (125° C., salt content 138656 ppm to 210000 ppm, polyvalent cations), afford Winsor type III microemulsions having very low to ultralow interfacial tensions of 0.0061 mN/m to 0.0089 mN/m. The broad variation in the salt content shows the robustness of the system.

TABLE 5
Temperature effect on solubilities in saline water and interfacial tension with surfactant mixture of ionic surfactant
(A) of the general formula (I) and anionic surfactant (B) of the general formula (II) in crude oil with API gravity 35

| | | | | | | Surfactant |
|---|---|---|---|---|---|---|
| | | | | | | solubility |
| | Surfactant formulation | | | SP* (or | | in salt |
| Exam- | with 10 g/L active | Salt | Water/oil | SPo) at | IFT at | solution at |
| ple | substance in salt solution | solution | ratio | temperature | temperature | temperature |
| 1 | 64 mol % | Salt content | 4:1 | 7 at 125° C. | 0.0061 | clearly |
| | C12C14N(CH₃)₂CH₂CO₂^{c} | 138656 ppm | | | mN/m at | soluble at |
| | to 36 mol % | (deposit | | | 125° C. | 125° C. |
| | C16C18—7PO—10EO—CH₂CO₂Na^{d} | water I) | | | | |
| 2 | 51 mol % | Salt content | 4:1 | 15 at 90° C. | 0.0013 | clearly |
| | C12C14N(CH₃)₂CH₂CO₂^{c} | 138656 ppm | | | mN/m at | soluble at |
| | to 49 mol % | (deposit | | | 90° C. | 90° C. |
| | C16C18—7PO—10EO—CH₂CO₂Na^{d} | water I) | | | | |
| C3 | 51 mol % | Salt content | 4:1 | no Winsor | >0.1 | clearly |
| | C12C14N(CH₃)₂CH₂CO₂^{c} | 138656 ppm | | type III | mN/m at | soluble at |
| | to 49 mol % | (deposit | | micro- | 80° C. | 80° C. |
| | C16C18—7PO—10EO—CH₂CO₂Na^{d} | water I) | | emulsion at | | |
| | | | | 80° C. | | |
| C4 | 64 mol % | Salt content | 4:1 | no Winsor | >0.1 | clearly |
| | C12C14N(CH₃)₂CH₂CO₂^{c} | 138656 ppm | | type III | mN/m at | soluble at |
| | to 36 mol % | (deposit | | micro- | 80° C. | 80° C. |
| | C16C18—7PO—10EO—CH₂CO₂Na^{d} | water I) | | emulsion at | | |
| | | | | 80° C. | | |
| C5 | 51 mol % | Salt content | 4:1 | no Winsor | >0.1 | clearly |
| | C12C14N(CH₃)₂CH₂CO₂^{c} | 138656 ppm | | type III | mN/m at | soluble at |
| | to 49 mol % | (deposit | | micro- | 25° C. | 25° C. |
| | C16C18—7PO—10EO—CH₂CO₂Na^{d} | water I) | | emulsion at | | |
| | | | | 25° C. | | |
| C6 | 64 mol % | Salt content | 4:1 | no Winsor | >0.1 | clearly |
| | C12C14N(CH₃)₂CH₂CO₂^{c} | 138656 ppm | | type III | mN/m at | soluble at |
| | to 36 mol % | (deposit | | micro- | 25° C. | 25° C. |
| | C16C18—7PO—10EO—CH₂CO₂Na^{d} | water I) | | emulsion at | | |
| | | | | 25° C. | | |

^{c}from Dehyton AB 30 [corresponding to ionic surfactant (A) of the general formula (I) with R¹ = nC₁₂H₂₅/C₁₄H₂₉, k = 1, R² = CH₃, R³ = (CH₂CO₂)⁻ and I = 0]
^{d}from ex. 2a) [corresponding to anionic surfactant (B) of the general formula (II) with R⁴ = nC₁₆H₃₃/C₁₈H₃₇, m = 0, n = 7, o = 10, p = 1, Y = CH₂CO₂ and M = Na]

As can be seen in examples 1 and 2 in table 5, claimed surfactant mixtures, under difficult field conditions (125° C. and also 90° C., salt content 138656 ppm in each case, polyvalent cations), afford Winsor type III microemulsions having very low to ultralow interfacial tensions of 0.0061 mN/m to 0.0013 mN/m. Comparative examples C3 to C6 indicate that at temperatures below 90° C., there is no sign of Winsor type III microemulsions and hence no sign of the desiredly ultralow interfacial tensions. Comparative examples C3 and C4 show the investigations at 80° C., using the surfactant mixtures described in examples 1 and 2—albeit at temperatures of <90° C. The same result is present for experiments at 25° C., which are set out in comparative examples C5 and C6.

TABLE 6
Solubilities in saltwater and interfacial tension with further surfactant mixture of ionic surfactant (A) of the
general formula (I) and anionic surfactant (B) of the general formula (II) in crude oil with API gravity 35

| | | | | | | Surfactant |
|---|---|---|---|---|---|---|
| | | | | | | solubility |
| | Surfactant formulation | | | SP* or | | in salt |
| Exam- | with 10 g/L active | Salt | Water/oil | SPo at | IFT at | solution at |
| ple | substance in solution | solution | ratio | 125° C. | 125° C. | 125° C. |
| 1 | 65 mol % | Salt content | 4:1 | 7.5 | 0.0053 | Clearly |
| | C16N(CH₃)₃Cl^{a} to | 138656 ppm | | | mN/m | soluble |
| | 35 mol % | (deposit | | | | |
| | C16C18—7PO—15EO—CH₂CO₂Na^{g} | water I) | | | | |
| 2 | 61 mol % | Salt content | 4:1 | 8 | 0.0047 | Clearly |
| | C16N(CH₃)₃Cl^{a} to | 138656 ppm | | | mN/m | soluble |
| | 39 mol % | (deposit | | | | |
| | C16C18—7PO—10EO—CH₂CO₂Na^{d} | water I) | | | | |
| 3 | 41 mol % | Salt content | 4:1 | 5.75 | 0.0091 | Clearly |
| | C16N(CH₃)₃Cl^{a} to | 138656 ppm | | | mN/m | soluble |
| | 59 mol % | (deposit | | | | |
| | C16C18—10EO—CH₂CO₂Na^{h} | water I) | | | | |
| 4 | 68 mol % | Salt content | 4:1 | 6 | 0.0083 | Clearly |
| | C12C14N(CH₃)₂CH₂CO₂^{c} | 138656 ppm | | | mN/m | soluble |
| | to 32 mol % | (deposit | | | | |
| | C16C18—7PO—15EO—CH₂CO₂Na^{g} | water I) | | | | |
| 5 | 64 mol % | Salt content | 4:1 | 7 | 0.0061 | Clearly |
| | C12C14N(CH₃)₂CH₂CO₂^{c} | 138656 ppm | | | mN/m | soluble |
| | to 36 mol % | (deposit | | | | |
| | C16C18-7PO-10EO-CH₂CO₂Na^{d} | water I) | | | | |
| C6 | 45 mol % (2- | Salt content | 4:1 | no Winsor | >0.1 | Turbid |
| | hydroxyethyl)(2- | 138656 ppm | | type III | mN/m | |
| | hydroxyhexadecyl)- | (deposit | | micro- | | |
| | dimethylammonium | water I) | | emulsion | | |
| | chloride^{f} to 55 mol % | | | | | |
| | C12—3EO—CH₂CH₂SO₃Naⁱ | | | | | |
| C7 | 45 mol % (2- | Salt content | 4:1 | 4.8 | 0.0130 | Slightly |
| | hydroxyethyl)(2- | 138656 ppm | | | mN/m | turbid |
| | hydroxyhexadecyl)- | (deposit | | | | |
| | dimethylammonium | water I) | | | | |
| | chloride^{f} to 55 mol % | | | | | |
| | C12—4EO—CH₂CO₂Na^{j} | | | | | |

^{a}from Dehyquart A-CA [corresponding to ionic surfactant (A) of the general formula (I) with R¹ = nC₁₆H₃₃, k = 1, R² = CH₃, R³ = CH₃, X = Cl and I = 1]
^{c}from Dehyton AB 30 [corresponding to ionic surfactant (A) of the general formula (I) with R¹ = nC₁₂H₂₅/C₁₄H₂₉, k = 1, R² = CH₃, R³ = (CH₂CO₂)⁻ and I = 0]
^{f}from Dehyquart E-CA [(2-hydroxyethyl)(2-hydroxyhexadecyl)dimethylammonium chloride]
^{g}from ex. 2c) [corresponding to anionic surfactant (B) of the general formula (II) with R⁴ = nC₁₆H₃₃/C₁₈H₃₇, m = 0, n = 7, o = 15, p = 1, Y = CH₂CO₂ and M = Na]
^{h}from ex. 2d) [corresponding to anionic surfactant (B) of the general formula (II) with R⁴ = nC₁₆H₃₃/C₁₈H₃₇, m = 0, n = 0, o = 10, p = 1, Y = CH₂CO₂ and M = Na]
ⁱalkyl ether sulfonate n-C₁₂H₂₅O—(CH₂CH₂O)₃—CH₂CH₂SO₃Na with a sulfonation level of 83%
^{j}alkyl ether carboxylate n-C₁₂H₂₅O—(CH₂CH₂O)₄—CH₂CO₂Na with a carboxymethylation level of 78%

As can be seen in examples 1, 2, 3, 4 and 5 in table 6, the claimed surfactant mixtures, under difficult field conditions (125° C., 138656 ppm salt content, polyvalent cations), afford Winsor type III microemulsions with very low to ultralow interfacial tensions of 0.0047 mN/m to 0.0091 mN/m. The comparison of example 1 with examples 2 and 3 shows that different anionic surfactants (B) were used (C16C18—7 PO—15 EO—CH₂CO₂Na and C16C18—7 PO—10 EO—CH₂CO₂Na and C16C18—10 EO—CH₂CO₂Na) but relatively similarly ultralow interfacial tensions were achieved. A similar case is present with examples 4 and 5 (C16C18—7 PO—15 EO—CH₂CO₂Na and also C16C18—7 PO—10 EO—CH₂CO₂Na). Also surprising is the finding in comparative examples C6 and C7. While the formulation in comparative example 7, which contains an alkyl ether carboxylate, results in a lowered interfacial tension of 0.013 mN/m, a Winsor type III microemulsion is not formed when an alkyl ether sulfonate is used (comparative example C6). Nor could such a microemulsion be found in other mixing ratios of the surfactants from comparative example C7.

TABLE 7
Viscosities of concentrates containing surfactants or surfactant mixture of ionic surfactant
(A) of the general formula (I) and anionic surfactant (B) of the general formula (II) at 40°
C. and 10 s⁻¹ (measured using Anton Paar MCR 302 instrument, CP50-0.3°, PP50)

| | | Viscosity 40° C. | | Appearance at |
|---|---|---|---|---|
| Example | Concentrate | und 10 s−1 | | 20° C. |
| 1 | 13.5 weight percent | 50 | mPas | liquid, very low |
| | C12C14N(CH₃)₂CH₂CO₂^{c}, 31.5 weight | | | viscosity |
| | percent C16C18—7PO—10EO—CH₂CO₂Na^{d} | | | |
| | (corresponding to ratio of 64 mol % | | | |
| | C12C14N(CH₃)₂CH₂CO₂^{c} to 36 mol % | | | |
| | C16C18—7PO—10EO—CH₂CO₂Na^{d}), | | | |
| | 8 weight percent butyl diethylene glycol, | | | |
| | 6 weight percent salt (primarily NaCl), | | | |
| | 41 weight percent water | | | |
| C2 | 45 weight percent | 480 | mPas | liquid |
| | C12C14N(CH₃)₂CH₂CO₂^{c}, 9 weight | | | |
| | percent salt (primarily NaCl), 46 weight | | | |
| | percent water | | | |
| C3 | 45 weight percent | 100 | mPas | liquid |
| | C16C18—7PO—10EO—CH₂CO₂Na^{d}, | | | |
| | 25 weight percent butyl | | | |
| | diethylene glycol, 5 weight percent salt | | | |
| | (primarily NaCl), 25 weight percent water | | | |
| C4 | 45 weight percent | 145000 | mPas | gel-like |
| | C12C14N(CH₃)₂CH₂CO₂^{c}, 9 weight | | | |
| | percent salt (primarily NaCl), 25 weight | | | |
| | percent sorbitol, 23 weight percent water | | | |
| C5 | 45 weight percent | 5830 | mPas | viscous |
| | C12C14N(CH₃)₂CH₂CO₂^{c}, 9 weight | | | |
| | percent salt (primarily NaCl), 10 weight | | | |
| | percent 1,6-hexanediol, 23 weight | | | |
| | percent water | | | |

^{c}from Dehyton AB 30 [corresponding to ionic surfactant (A) of the general formula (I) with R¹ = nC₁₂H₂₅/C₁₄H₂₉, k = 1, R² = CH₃, R³ = (CH₂CO₂)⁻ and I = 0]
^{d}from ex. 2a) [corresponding to anionic surfactant (B) of the general formula (II) with R⁴ = nC₁₆H₃₃/C₁₈H₃₇, m = 0, n = 7, o = 10, p = 1, Y = CH₂CO₂ and M = Na]

As can be seen in examples 1, C2 and C3 from table 7, the claimed surfactant mixture surprisingly affords the lowest viscosity (example 1 with 50 mPas at 40° C. and 10 s⁻¹ shear rate) for the same active content of 45 weight percent of surfactant. The individual surfactants (comparative example C2 and example C3) in contrast, afforded higher values, at 45 weight percent active content.

Comparative examples C4 and C5 engage the addition of specific polyols described in WO 95/14658. As is apparent, however, very high viscosities are obtained in this case (comparative example C4: 145 000 mPas at 40° C. and 10 s⁻¹, and gel-like state at 20° C.; comparative example C5: 5830 mPas at 40° C. and 10 s⁻¹). One cause may be that a different kind of betaine is present (WO 95/14658 describes betaines containing amide groups). As specified in comparative example C1 from table 1 in WO 95/14658, the addition of the polyol glycerol is counterproductive, since surprisingly it leads to gelled products. Apparently there is a very specific interaction of polyols with certain betaine surfactants. Comparing comparative example C2 with example 1 it is found that the claimed mixture has a viscosity one order of magnitude lower (480 versus 50 mPas at 40° C. and 10 s⁻¹). If a polyol subject to the claims of WO 95/14658 is added to the mixture from comparative example C2, it is seen that the comparative example C5 has a viscosity higher by one order of magnitude (480 versus 5830 mPas at 40° C. and 10 s⁻¹).

TABLE 8
Storage stability of ionic surfactant (A) of the general formula (I) and of anionic surfactant (B) of the
general formula (II) and of anionic hydrotrope (C) of the general formula (III) in saltwater at 125° C.

| | | | Intact | Intact | Intact | Intact |
|---|---|---|---|---|---|---|
| | | | surfactant/ | surfactant/ | surfactant/ | surfactant/ |
| | | | hydrotrope | hydrotrope | hydrotrope | hydrotrope |
| | Surfactant/hydrotrope with | | after 2 | after 4 | after 8 | after 12 |
| Exam- | 5 g/L active substance | Salt | weeks at | weeks at | weeks at | weeks at |
| ple | in salt solution | solution | 125° C. | 125° C. | 125° C. | 125° C. |
| 1 | C16C18—7PO—10EO—CH₂CO₂Na^{d} | 10000 ppm | 100% | 100% | 100% | 100% |
| | | NaCl (pH 8) | | | | |
| C2 | (2-Hydroxyethyl)- | Synthetic | 92% | 88% | 82% | 75% |
| | (2-hydroxyhexa- | seawater | | | | |
| | decyl)dimethyl- | with 43910 | | | | |
| | ammonium | ppm TDS | | | | |
| | chloride^{f} | (pH 8) | | | | |
| 3 | C16N(CH₃)₃Cl^{a} | Synthetic | 98% | 94% | 92% | 90% |
| | | seawater | | | | |
| | | with 43910 | | | | |
| | | ppm TDS | | | | |
| | | (pH 8) | | | | |
| 4 | C12C14N(CH₃)₂CH₂CO₂^{c} | Deposit | 100% | 98% | 93% | 90% |
| | | water II with | | | | |
| | | 234370 | | | | |
| | | ppm TDS | | | | |
| | | (pH 6) | | | | |
| 5 | C4—2EO—CH₂CO₂Na^{e} | Deposit | 100% | 100% | 100% | 100% |
| | | water II with | | | | |
| | | 234370 | | | | |
| | | ppm TDS | | | | |
| | | (pH 6) | | | | |

^{a}from Dehyquart A-CA [corresponding to ionic surfactant (A) of the general formula (I) with R¹ = nC₁₆H₃₃, k = 1, R² = CH₃, R³ = CH₃, X = Cl and I = 1]
^{c}from Dehyton AB 30 [corresponding to ionic surfactant (A) of the general formula (I) with R¹ = nC₁₂H₂₅/C₁₄H₂₉, k = 1, R² = CH₃, R³ = (CH₂CO₂)⁻ and I = 0]
^{d}from ex. 2a) [corresponding to anionic surfactant (B) of the general formula (II) with R⁴ = nC₁₆H₃₃/C₁₈H₃₇, m = 0, n = 7, o = 10, p = 1, Y = CH₂CO₂ and M = Na]
^{f}from Dehyquart E-CA [(2-hydroxyethyl)(2-hydroxyhexadecyl)dimethylammonium chloride]
^{e}from ex. 3a) [corresponding to anionic hydrotrope (C) of the general formula (III) with R⁶—O—(CH₂CH₂O)_{q}—CH₂CO₂_{^{−}} M⁺ with R⁶ = n-C₄H₉, q = 2, and M = Na]

As can be seen in example 1 from table 8, the anionic surfactant (B) of the general formula (III) in the absence of oxygen is stable at 125° C. for 12 weeks (not depicted in the table are further tests showing that the surfactant from example 1 remains fully stable at 150° C. for 12 weeks as well). Because of the surfactant solubility at 125° C., the test in this example was carried out in 1% sodium chloride solution. The noninventive cationic surfactant in comparative example C2 in table 8, in contrast, exhibits significant breakdown. After 12 weeks at 125° C., only 75% of the original amount is still intact. This is hardly surprising, since cationic surfactants may be subject to Hofmann elimination, which may occur at high temperatures in particular. In the Hofmann elimination, quaternary ammonium compounds possessing H atoms in 3-position are broken down into tertiary amines. Very much more surprising, on the other hand, is the finding from examples 3 and 4. The cationic and betaine surfactants (A) of the invention, of the general formula (I), are significantly more stable at 125° C. Hence after 12 weeks at 125° C., there is still 90% of the initial amount of intact surfactant recovered. As can be seen in example 5 from table 8, the anionic hydrotrope (C) of the general formula (III) in the absence of oxygen is stable for 12 weeks at 125° C.

TABLE 9
Solubilities in saltwater of different salinity and interfacial tension with surfactant mixture of
ionic surfactant (A) of the general formula (I) and anionic surfactant (B) of the general formula
(II) with and without hydrotrope (C) of the general formula (III) in crude oil with API gravity 35

| | | | | | | Surfactant |
|---|---|---|---|---|---|---|
| | | | | | | solubility |
| | | | | SP* (or | | in salt |
| Exam- | Surfactant formulation | Salt | Water/oil | SPo) at | IFT at | solution at |
| ple | with in salt solution | solution | ratio | 125° C. | 125° C. | 125° C. |
| 1 | 10 g/L active substance | Salt content | 4:1 | 5.8 | 0.009 | clearly |
| | consisting of 69 mol % | 210000 ppm | | | mN/m | soluble |
| | C12C14N(CH₃)₂CH₂CO₂^{c} | (deposit | | | | |
| | to 31 mol % | water II | | | | |
| | C16C18—7PO—10EO—CH₂CO₂Na^{d} | diluted with | | | | |
| | | fully | | | | |
| | | demineralized | | | | |
| | | water) | | | | |
| 2 | 10 g/L active substance | Salt content | 4:1 | 5.8 | 0.009 | turbid |
| | consisting of 69 mol % | 220000 ppm | | | mN/m | |
| | C12C14N(CH₃)₂CH₂CO₂^{c} | (deposit | | | | |
| | to 31 mol % | water II | | | | |
| | C16C18—7PO—10EO—CH₂CO₂Na^{d} | diluted with | | | | |
| | | fully | | | | |
| | | demineralized | | | | |
| | | water) | | | | |
| 3 | 10 g/L active substance | Salt content | 4:1 | 5.8 | 0.009 | turbid |
| | consisting of 69 mol % | 234370 ppm | | | mN/m | |
| | C12C14N(CH₃)₂CH₂CO₂^{c} | (deposit | | | | |
| | to 31 mol % | water II) | | | | |
| | C16C18—7PO—10EO—CH₂CO₂Na^{d} | | | | | |
| 4 | 10 g/L active substance | Salt content | 4:1 | 5.8 | 0.009 | turbid |
| | consisting of 69 mol % | 240000 ppm | | | mN/m | |
| | C12C14N(CH₃)₂CH₂CO₂^{c} | (concentrated | | | | |
| | to 31 mol % | deposit water | | | | |
| | C16C18—7PO—10EO—CH₂CO₂Na^{d} | II) | | | | |
| 5 | 10 g/L active substance | Salt content | 4:1 | 5.8 | 0.009 | clearly |
| | consisting of 69 mol % | 234370 ppm | | | mN/m | soluble |
| | C12C14N(CH₃)₂CH₂CO₂^{c} | (concentrated | | | | |
| | to 31 mol % | deposit water | | | | |
| | C16C18—7PO—10EO—CH₂CO₂Na^{d} | II) | | | | |
| | and 5 g/L active substance | | | | | |
| | C4—2EO—CH₂CO₂Na^{e} | | | | | |
| 6 | 10 g/L active substance | Salt content | 4:1 | 2.9 | 0.036 | clearly |
| | consisting of 69 mol % | 234370 ppm | | | mN/m | soluble |
| | C12C14N(CH₃)₂CH₂CO₂^{c} | (concentrated | | | | |
| | to 31 mol % | deposit water | | | | |
| | C16C18—7PO—10EO—CH₂CO₂Na^{d} | II) | | | | |
| | and 10 g/L active substance | | | | | |
| | C4—2EO—CH₂CO₂Na^{e} | | | | | |
| 7 | 10 g/L active substance | Salt content | 4:1 | 5 | 0.012 | turbid |
| | consisting of 69 mol % | 234370 ppm | | | mN/m | |
| | C12C14N(CH₃)₂CH₂CO₂^{c} | concentrated | | | | |
| | to 31 mol % | deposit water | | | | |
| | C16C18—7PO—10EO—CH₂CO₂Na^{d} | II) | | | | |
| | and 10 g/L | | | | | |
| | butyldiethylene glycol | | | | | |
| C8 | 10 g/L active substance | Salt content | 4:1 | — | >0.1 | clearly |
| | consisting of 69 mol % | 234370 ppm | | | mN/m | soluble |
| | C12C14N(CH₃)₂CH₂CO₂^{c} | concentrated | | | | |
| | to 31 mol % | deposit water | | | | |
| | C16C18—7PO—10EO—CH₂CO₂Na^{d} | II) | | | | |
| | and 20 g/L | | | | | |
| | cumenesulfonate | | | | | |
| | sodium salt | | | | | |

^{c}from Dehyton AB 30 [corresponding to ionic surfactant (A) of the general formula (I) with R¹ = nC₁₂H₂₅/C₁₄H₂₉, k = 1, R² = CH₃, R³ = (CH₂CO₂)⁻ and I = 0]
^{d}from ex. 2a) [corresponding to anionic surfactant (B) of the general formula (II) with R⁴ = nC₁₆H₃₃/C₁₈H₃₇, m = 0, n = 7, o = 10, p = 1, Y = CH₂CO₂ and M = Na]
^{e}from ex. 3a) [corresponding to anionic hydrotrope (C) of the general formula (III) with R⁶—O—(CH₂CH₂O)_{q}—CH₂CO₂_{^{−}} M⁺ with R⁶ = n-C₄H₉, q = 2, and M = Na]

As can be seen in example 1, table 9, the surfactant mixture, under difficult field conditions (125° C., 210000 ppm salt content, polyvalent cations), affords Winsor type III microemulsions with very low to ultralow interfacial tensions of 0.009 mN/m. If, however, the salinity is increased (examples 2, 3 and 4), then the surfactant mixture does still form Winsor type III microemulsions with ultralow interfacial tensions, but the surfactant mixture is no longer clearly soluble in water under the reservoir conditions. A turbid solution is present which becomes a two-phase mixture over time. If pumped into the formation, therefore, there could be separation of the surfactant mixture before it manages to reach the crude oil, since the region around the injector may be extremely low in oil because of the years of water flooding. Example 7 shows how the addition of butyl diethylene glycol as cosolvent no longer produces any improvement in the solubility at extremely high salinities. If, instead, a conventional hydrotrope such as cumenesulfonate sodium salt is used (comparative example 8), then the surfactant formulation becomes clearly soluble again in the water under the reservoir conditions, but there are no longer any Winsor type III microemulsions formed in the presence of oil. Only by using the claimed hydrotrope (C) of the general formula (III) (examples 5 and 6) is success achieved in terms of the optimum unitability of clear solubility in water under reservoir conditions with the development of Winsor type III microemulsions in the presence of crude oil. Consequently, the clear surfactant formulations afford very low to ultralow interfacial tensions between oil and water.

1. A method of producing mineral oil from underground mineral oil deposits, in which an aqueous saline surfactant formulation comprising a surfactant mixture, for the purpose of lowering the interfacial tension between oil and water to <0.1 mN/m, is injected into a mineral oil deposit through at least one injection well and crude oil is withdrawn from the deposit through at least one production well, wherein
the mineral oil deposit has a temperature of >90° C. and a formation water having a salinity of ≥30 000 ppm of dissolved salts
and the surfactant mixture comprises at least one ionic surfactant (A) of the general formula (I)
(R¹)ₖ—N⁺(R²)₍₃₋ₖ₎R³(X⁻)ₗ (I)
and at least one anionic surfactant (B) of the general formula (II)
R⁴—O—(CH₂C(R)HO)ₘ—(CH₂C(CH)HO)ₙ—(CH₂CH₂)ₒ—(CH₂)ₚ—Y⁻M⁺ (II)
with a molar ratio of ionic surfactant (A) to anionic surfactant (B) in the surfactant mixture on injection of 90:10 to 10:90,
where
each R¹ is independently a linear or branched, saturated or unsaturated, aliphatic hydrocarbyl radical having 8 to 22 carbon atoms or is the R⁴—O—(CH₂C(R⁵)HO)ₘ—(CH₂C(CH₃)HO)ₙ—(CH₂CH₂O)ₒ—(CH₂CH₂)— or R⁴—O—(CH₂C(R⁵)HO)ₘ—(CH₂C(CH₃)HO)ₙ—(CH₂CH₂O)ₒ)—(CH₂C(CH₃)H)— radical;
each R² is CH₃;
R³ is CH₃ or (CH₂CO₂)—;
each R⁴ is independently a linear or branched, saturated or unsaturated, aliphatic hydrocarbyl radical having 8 to 36 carbon atoms or an aromatic or aromatic-aliphatic hydrocarbyl radical having 8 to 36 carbon atoms;
each R⁵ is independently a linear or branched, saturated or unsaturated, aliphatic hydrocarbyl radical having 2 to 16 carbon atoms or an aromatic or aromatic-aliphatic hydrocarbyl radical having 6 to 10 carbon atoms;
X is Cl, Br, I or H₃CO—SO₃;
Y is CO₂ or SO₃;
M is Na, K, N(CH₂CH₂OH)₃H, N(CH₂CH(CH₃)OH)₃H, N(CH₃)(CH₂CH₂OH)₂H, N(CH₃)₂(CH₂CH₂OH)H, N(CH₃)₃(CH₂CH₂OH), N(CH₃)₃H, N(C₂H₅)₃H or NH₄;
k is the number 1 or 2,
l is the number 0 or 1;
each m is independently a number from 0 to 15;
each n is independently a number from 0 to 50;
each o is independently a number from 1 to 60;
each p is independently a number from 1 to 4;
where
the sum total of n+o is a number from 7 to 80;
p is the number 1 if Y is CO₂;
p is the number 2, 3 or 4 if Y is SO₃;
l is the number 0 if R³ is (CH₂CO₂)⁻ or is 1 if R³ is CH₃.

2. The method according to claim 1, wherein the surfactant formulation further comprises at least one anionic compound (C) of the general formula (III)
R⁶—O—(CH₂CH₂O)_{q}—CH₂CO₂⁻M⁺ (III)
where R⁶ is a linear or branched, saturated aliphatic hydrocarbyl radical having 1 to 5 carbon atoms or is a phenyl radical, M has the definition of M for formula (II) and is selected independently thereof, and q is a number from 1 to 9.

3. The method according to claim 2 or 3, wherein R⁶ is a methyl, ethyl, n-propyl, isopropyl, n-butyl, isobutyl, n-pentyl, isopentyl or phenyl radical.

4. The method according to either of claims 2 and 3, wherein q is a number from 1 to 4.

5. The method according to any of claims 1 to 4, wherein there is a molar ratio of ionic surfactant (A) to anionic surfactant (B) in the surfactant mixture on injection of 85:15 to 35:65, preferably 80:20 to 55:45, more preferably 79:21 to 58:42.

6. The method according to any of claims 2 to 5, wherein the weight ratio of the at least one anionic compound (C) to the surfactant mixture is in the range from 3:1 to 1:9.

7. The method according to any of claims 1 to 6, wherein R¹ is a linear or branched, saturated or unsaturated, aliphatic hydrocarbyl radical having 12 to 18 carbon atoms, preferably a linear aliphatic hydrocarbyl radical having 12 to 18 carbon atoms, more preferably a linear aliphatic hydrocarbyl radical having 12 to 16 carbon atoms.

8. The method according to any of claims 1 to 7, wherein R⁴ is a linear or branched, saturated or unsaturated, aliphatic hydrocarbyl radical having 12 to 30, preferably 13 to 19, carbon atoms and/or R⁴ has a degree of branching of 0, 1, 2, 3 or 4, preferably 0 or 1.

9. The method according to any of claims 1 to 8, wherein R⁵ is a saturated hydrocarbyl radical having 2 to 14 carbon atoms.

10. The method according to any of claims 1 to 9, wherein at least one of the following conditions is fulfilled:
k=1;
m=0;
n=0 to 30, preferably 0 to 15 or 5 to 20, more preferably 7 to 15, more preferably n=0;
o=3 to 50, preferably 5 to 35, more preferably 10 to 25;
the sum total of n+o is a number from 7 to 50, preferably from 7 to 45, more preferably from 7 to 35, more preferably from 7 to 25;
p=2 and Y═SO₃ or p=1 and Y═CO₂.

11. The method according to any of claims 1 to 10, wherein Y is CO₂ and p is 1.

12. The method according to any of claims 1 to 11, wherein I=1 and R³═CH₃ and X═H₃CO—SO₃ or Cl.

13. The method according to any of claims 1 to 11, wherein I=0 and R³═(CH₂CO₂)⁻.

14. The method according to any of claims 1 to 13, wherein M is Na and/or X is Cl.

15. The method according to any of claims 1 to 14, wherein mineral oil is produced from underground mineral oil deposits by means of Winsor type III microemulsion flooding.

16. The method according to any of claims 1 to 15, wherein at least one of the following conditions is fulfilled in relation to the mineral oil deposit:
the mineral oil deposit comprises carbonate rock;
the deposit temperature is ≥90° C., preferably ≥100° C., more preferably ≥110° C.;
the salinity of the formation water is >50 000 ppm, preferably ≥100 000 ppm, and more preferably ≤210 000 ppm of dissolved salts.

17. The method according to any of claims 2 to 16, wherein the salinity of the formation water is >210 000 ppm of dissolved salts.

18. A concentrate comprising, based in each case on the total amount of the concentrate,
20% by weight to 90% by weight of at least one ionic surfactant (A) of the general formula (I) as specified in any of claims 1, 5 and 7 to 14 or of at least one anionic surfactant (B) of the general formula (II) as specified in any of claims 1, 5 and 7 to 14 or of a surfactant mixture as specified in any of claims 1, 5 and 7 to 14, where the molar ratio of ionic surfactant (A) to anionic surfactant (B) may be as desired,
5% by weight to 40% by weight of water and
5% by weight to 40% by weight of a cosolvent.

19. The concentrate according to claim 18, wherein the cosolvent is selected from the group of the aliphatic alcohols having 3 to 8 carbon atoms or from the group of the alkyl monoethylene glycols, the alkyl diethylene glycols or the alkyl triethylene glycols, where the alkyl radical is an aliphatic hydrocarbyl radical having 3 to 6 carbon atoms.

20. The concentrate according to claim 18 or 19, wherein the concentrate is free-flowing at 20° C. and at 40° C. has a viscosity of <5000 mPas at 10 s⁻¹.

21. A concentrate comprising
20% by weight to 80% by weight of at least one ionic surfactant (A) of the general formula (I) as specified in any of claims 1 to 9 or of at least one anionic surfactant (B) of the general formula (II) as specified in any of claims 1 to 9 or of a surfactant mixture as specified in any of claims 1 to 9, where the molar ratio of ionic surfactant (A) to anionic surfactant (B) may be as desired ratio of ionic surfactant (A) to anionic surfactant (B) may be as desired;
70% by weight to 10% by weight of at least one anionic compound (C) of the general formula (III) as specified in any of claims 2 to 4 and 6;
10% by weight to 70% by weight of water.

22. The use of a surfactant mixture as specified in any of claims 1, 5 and 7 to 14 or of a concentrate according to any of claims 18 to 21 for production of mineral oil from underground mineral oil deposits, especially according to claims 15 to 17.

23. The use of a surfactant formulation as specified in any of claims 1 to 14 for production of mineral oil from underground mineral oil deposits, especially according to claims 15 to 17.
